(19) United States
(12) Patent Application Publication
(10) Pub. No.: US 2024/0167906 A1
(43) Pub. Date: May 23, 2024

(54) AQUEOUS SOLUTION LEAK DETECTION CABLE

(71) Applicant: Raymond & Lae Engineering, LLC, Fort Collins, CO (US)

(72) Inventors: Donald M. Raymond, Fort Collins, CO (US); James Schneider, Fort Collins, CO (US)

(73) Assignee: Raymond & Lae Engineering, LLC, Fort Collins, CO (US)

(21) Appl. No.: 18/511,799

(22) Filed: Nov. 16, 2023

Related U.S. Application Data
(63) Continuation-in-part of application No. 17/989,525, filed on Nov. 17, 2022.

(51) Int. Cl. G01M 3/04

(52) U.S. Cl. CPC G01M 3/045

(57) ABSTRACT

Disclosed is a aqueous solution leak detection cable that locates aqueous solution leaks in pipelines, tanks, and other devices that store and transport aqueous solutions. Resistive sensor wires are used so that the location of the leak can be detected with a high degree of accuracy in an inexpensive and convenient matter. In addition, aqueous solution leaks can be detected over long distances, which reduces the cost and provides reliability for detecting aqueous solution leaks in aqueous solution pipelines.

### CROSS-REFERENCE TO RELATED APPLICATIONS

The present U.S. Utility Application claims priority pursuant to 35 U.S.C. § 120 as a continuation-in-part of U.S. Utility patent application Ser. No. 17/989,525, entitled, “HYDROCARBON LEAK DETECTION CABLE,” filed on Nov. 17, 2022, and is incorporated herein by reference in its entirety for all that it discloses and teaches, and is further made part of the present application for all purposes.

### BACKGROUND

Monitoring of leaks of water and water solutions, including deionized water (hereafter collectively referred to as “aqueous solutions”) is important in protecting the environment. Aqueous solution leaks can occur from both underground and above ground storage tanks, pipelines, transfer pipes and tubing and machinery. Leaks can cause serious harm. Detection of leaks is therefore advantageous and important.

Various methods and devices have been used to detect aqueous solution leaks. For example, U.S. Utility Pat. No. 7,081,759, entitled, “Fluid Detection Cable,” issued on Jul. 25, 2006, discloses one method of detecting aqueous solution leaks. This patent is specifically incorporated herein by reference for all that it discloses and teaches and is made part of the present U.S. Utility Application.

### SUMMARY

An embodiment of the present invention may therefore comprise: an aqueous solution leak detection cable comprising: a feedback wire having feedback conductors and insulators surrounding the feedback conductors; sensor wires disposed adjacent to the insulators and separated by the insulators, the sensor wires having a uniform resistance per unit of length; a compressible conductive covering that surrounds the feedback wire and the sensor wires that is placed over the feedback wire and the sensor wire so that a gap is formed between the compressible conductive covering and the sensor wires; an aqueous solution reactive polymer that expands in the presence of an aqueous solution that surrounds the compressible conductive covering; a non-expandable permeable cover surrounding the aqueous solution reactive polymer that is permeable to an aqueous solution and directs forces from expansion of the aqueous solution reactive polymer, as a result of absorption of the aqueous solution, in an inward direction which causes the compressible conductive covering to move inwardly towards the sensor wires and contact the sensor wires to create electrical conduction between the sensor wires where the aqueous solution reactive polymer expands.

An embodiment of the present invention may further comprise: an aqueous solution leak detection cable comprising: a feedback wire having feedback conductors and insulators surrounding the feedback conductors; sensor wires disposed adjacent to the insulators and separated by the insulators, the sensor wires having a uniform resistance per unit of length at the sensor wires; a conductive aqueous solution reactive polymer placed over the feedback wire and the sensor wire that expands in the presence of aqueous solutions; a non-expandable permeable cover surrounding the conductive aqueous solution reactive polymer that is permeable to aqueous solutions and directs forces from expansion of the conductive aqueous solution reactive polymer, as a result of absorption of aqueous solutions, in an inward direction which causes the conductive aqueous solution reactive polymer to move inwardly towards the sensor wires and contact the sensor wires to create electrical conduction between the sensor wires.

An embodiment of the present invention may further comprise: a method of making an aqueous solution leak detection cable comprising: providing feedback wire that has at least two feedback conductors; providing insulators that surround the feedback conductors, the insulators connected to form recesses between the insulators; placing sensor wires in the recesses between the conductors; placing a compressible conductive covering over the insulators and the sensor wires so that a gap is formed between the sensor wires and the compressible conductive covering; placing an aqueous solution reactive polymer over the compressible conductive covering that expands in the presence of aqueous solutions and creates forces on the compressible conductive covering to cause the compressible conductive covering to contact the sensor wires and create a conductive path between the sensor wires at a location where the aqueous solution reactive polymer has absorbed an aqueous solution from an aqueous solution leak; placing a non-expandable permeable cover on the aqueous solution reactive polymer that protects the aqueous solution leak detection cable, and causes forces created by the aqueous solution reactive polymer, as a result of the aqueous solution reactive polymer expanding in the presence of aqueous solution, to be directed inwardly towards the compressible conductive covering.

An embodiment of the present invention may further comprise: a method of making an aqueous solution leak detection cable comprising: providing feedback wire that has at least two feedback conductors; providing insulators that surround the feedback conductors, the insulators connected to form recesses between the insulators; placing sensor wires in the recesses between the conductors; placing a conductive aqueous solution reactive polymer over the sensor wires and the insulators that expands in the presence of an aqueous solution and creates forces on the compressible conductive covering to cause the compressible conductive covering to contact the sensor wires and create a conductive path between the sensor wires at a location where the conductive aqueous solution reactive polymer has absorbed an aqueous solution from an aqueous solution leak; placing a non-expandable permeable cover on the conductive aqueous solution reactive polymer that protects the aqueous solution leak detection cable and causes forces created by the conductive aqueous solution reactive polymer, as a result of the conductive aqueous solution reactive polymer expanding in the presence of an aqueous solution, to be directed inwardly towards the compressible conductive covering.

An embodiment of the present invention may further comprise: a method of making an aqueous solution leak detection cable comprising: providing a feedback wire having feedback conductors and insulators surrounding the feedback conductors; placing sensor wires adjacent to the insulators; placing a compressible conductive covering that surrounds the feedback wire and the sensor wires so that gaps are created between the sensor wires and the compressible conductive covering; placing a layer of an aqueous solution reactive polymer over the compressible conductive covering that expands in the presence of aqueous solutions and causes the compressive conductor to extend into the gaps and create a conductive path between the sensor wires.

An embodiment of the present invention may further comprise: a method of detecting a location of an aqueous solution leak in an aqueous solution leak detection cable comprising: using a layer of aqueous solution reactive polymer that surrounds a compressible conductive covering so that a gap is formed between the aqueous solution reactive polymer, the compressible conductive covering placed over sensor wires so that a gap is formed between the compressible conductive covering and the sensor wires; detecting an aqueous solution leak at the location on the aqueous solution leak detection cable by allowing a liquid aqueous solution from the aqueous solution leak to penetrate the aqueous solution leak detection cable at the location causing the aqueous solution reactive polymer to absorb the liquid aqueous solution, which causes the aqueous solution reactive polymer to swell so that the compressible conductive covering extends into the gaps and creates a conductive path between the sensor wires at the location; using detector electronics to determine where on the aqueous solution leak detection cable the conductive path has occurred to determine the location of the aqueous solution leak.

An embodiment of the present invention may further comprise: a method of making an aqueous solution leak detection cable comprising: providing a feedback wire having feedback conductors and insulators surrounding the feedback conductors; placing sensor wires adjacent to the insulators; placing a layer of a conductive aqueous solution reactive polymer over the feedback wire and the sensor wires so that gaps are created between the sensor wires and the conductive aqueous solution reactive polymer, the conductive aqueous solution reactive polymer expanding in the presence of an aqueous solution and extending into the gaps to create an electrically conductive path between the sensor wires.

An embodiment of the present invention may further comprise: a method of detecting a location of an aqueous solution leak in an aqueous solution leak detection cable comprising: placing a layer of a conductive aqueous solution reactive polymer on resistive sensor wires that covers resistive sensor wires in the aqueous solution leak detection cable; detecting an aqueous solution leak at the location on the aqueous solution leak detection cable by allowing an aqueous solution from the aqueous solution leak to penetrate the aqueous solution leak detection cable at the location causing the conductive aqueous solution reactive polymer to absorb the aqueous solution, which causes the conductive aqueous solution reactive polymer to swell and expand into gaps between the conductive aqueous solution reactive polymer and the resistive sensor wires to create an electrically conductive path between the sensor wires at the location; using detector electronics to determine where on the aqueous solution leak detection cable the conductive path has occurred to determine the location of the aqueous solution leak.

### BRIEF DESCRIPTION OF THE DRAWINGS

FIG. 1 is a partial cut-away view of an embodiment of a aqueous solution leak detection cable.

FIG. 2 is a side view of the aqueous solution leak detection cable in FIG. 1.

FIG. 3 is a cross-sectional view of the aqueous solution leak detection cable illustrated in FIGS. 1 and 2, at the location indicated in FIG. 2.

FIG. 4 is a partial cut-away view of another embodiment of a aqueous solution leak detection cable.

FIG. 5 is a side view of the aqueous solution leak detection cable in FIG. 4.

FIG. 6 is a cross-sectional view of the aqueous solution leak detection cable illustrated in FIGS. 4 and 5, at the location indicated in FIG. 5.

FIG. 7 is a partial cut-away view of another embodiment of a aqueous solution leak detection cable.

FIG. 8 is a side view of the aqueous solution leak detection cable in FIG. 7.

FIG. 9 is a cross-sectional view of the aqueous solution leak detection cable illustrated in FIGS. 7 and 8, at the location indicated in FIG. 8.

FIG. 10 is a partial cut-away view of another embodiment of a aqueous solution leak detection cable.

FIG. 11 is a side view of the aqueous solution leak detection cable in FIG. 10.

FIG. 12 is a cross-sectional view of the aqueous solution leak detection cable illustrated in FIGS. 10 and 11, at the location indicated in FIG. 11.

FIG. 13 is a partial cut-away view of another embodiment of a aqueous solution leak detection cable.

FIG. 14 is a side view of the aqueous solution leak detection cable in FIG. 13.

FIG. 15 is a cross-sectional view of the aqueous solution leak detection cable illustrated in FIGS. 13 and 14, at the location indicated in FIG. 14.

FIG. 16 is a partial cut-away view of another embodiment of a aqueous solution leak detection cable.

FIG. 17 is a side view of the aqueous solution leak detection cable in FIG. 16.

FIG. 18 is a cross-sectional view of the aqueous solution leak detection cable illustrated in FIGS. 16 and 17, at the location indicated in FIG. 17.

FIG. 19 is a partial cut-away view of another embodiment of a aqueous solution leak detection cable.

FIG. 20 is a side view of the aqueous solution leak detection cable in FIG. 19.

FIG. 21 is a cross-sectional view of the aqueous solution leak detection cable illustrated in FIGS. 19 and 20, at the location indicated in FIG. 20.

FIG. 22 is a partial cut-away view of another embodiment of a aqueous solution leak detection cable.

FIG. 23 is a side view of the aqueous solution leak detection cable in FIG. 22.

FIG. 24 is a cross-sectional view of the aqueous solution leak detection cable illustrated in FIGS. 22 and 23, at the location indicated in FIG. 23.

FIG. 25 is a partial cut-away view of another embodiment of a aqueous solution leak detection cable.

FIG. 26 is a side view of the aqueous solution leak detection cable in FIG. 25.

FIG. 27 is a cross-sectional view of the aqueous solution leak detection cable illustrated in FIGS. 25 and 26, at the location indicated in FIG. 26.

FIG. 28 is a schematic depiction of the use of the aqueous solution leak detection system for detecting aqueous solution leaks in a pipeline.

FIG. 29 is a more detailed schematic view of the aqueous solution leak detection system for detecting aqueous solution leaks in pipelines.

### DETAILED DESCRIPTION OF THE EMBODIMENTS

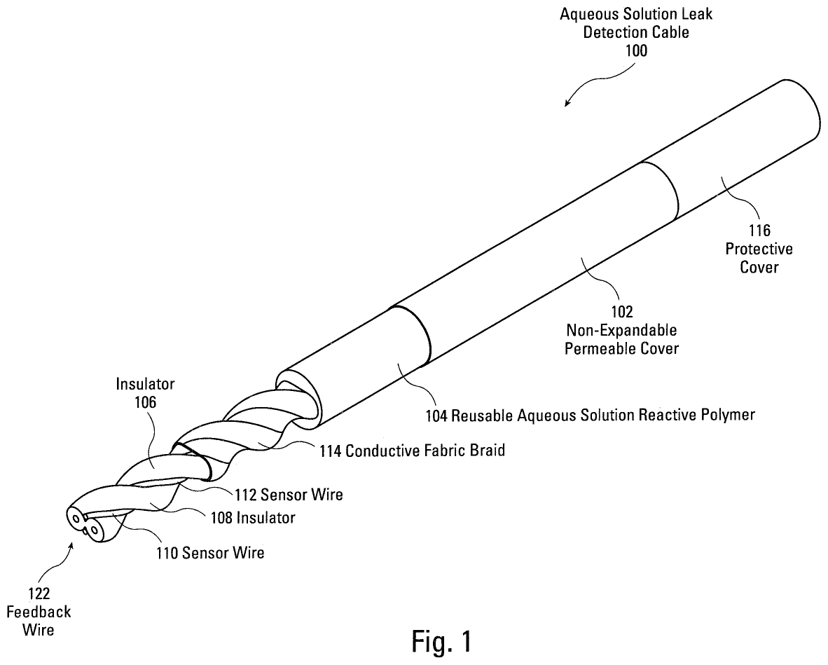

FIG. 1 is a partial cut-away view of an embodiment of a aqueous solution leak detection cable 100. As illustrated in FIG. 1, the aqueous solution leak detection cable 100 has a non-expandable permeable cover 102. The non-expandable permeable cover 102 is intended to protect the aqueous solution leak detection cable 100 from abrasions, punctures, and other potential damage. The non-expandable permeable cover 102 may be constructed from a plastic monofilament fiber that is braided in a manner that provides protection to the underlying layers. The monofilament fiber can be constructed from various plastics, and normally has a coverage of approximately 80%, so that 20% of the surface of the non-expandable permeable cover 102 is open to allow the passage of an aqueous solution. Of course, those percentages can be used including 90/10, 70/30, for example. The non-expandable permeable cover 102 may also be made from various types of polymer tape having perforations to allow the passage of a water liquid. Various other types of materials can be used to produce the non-expandable permeable cover 102 which does not allow substantial expansion as a result of forces created by the reusable reactive polymer 104. In that regard, substantial expansion means that the non-expandable permeable cover 102 expands by more than about 5% of its diameter.

Under the non-expandable permeable cover 102, illustrated in FIG. 1, is a reusable aqueous solution reactive polymer 104. In that regard, each of the layers or coverings illustrated in all of the embodiments may include additional layers. Other additional layers may exist, and it should be understood by those skilled in the art that the description provided herein, and the claims set forth hereafter, disclose a structure which may include additional layers or coverings. Terms such as “under,” “cover,” “on,” “surrounds,” and similar terms do not mean that any particular layer is directly connected to or directly adjacent to any other layer, but rather, other layers can exist in the structures in the embodiments disclosed. Further, these terms do not mean or imply “complete,” but may be “partial.”

Referring again to FIG. 1, an aqueous solution that passes through the non-expandable permeable cover 102 reacts with the reusable reactive polymer 104 which expands or swells when subjected to, or placed in contact with, aqueous solutions. The reusable aqueous solution reactive polymer 104 may comprise a hydrogel which absorbs aqueous solutions.

The term hydrogel is used to denote materials that absorb water and swell. In that regard, hydrogels can absorb water or water mixed with other solutions that may form an aqueous solution. For purposes of this disclosure and the appending claims, the term “aqueous solution” is used herein to denote water itself, including deionized water, purified water, and mixtures of water with other solutions to form a liquid that is defined herein as an “aqueous solution.” Accordingly, the term “aqueous solution,” as used herein, includes any type of liquid solution that includes water, as well as water itself, including pure water and other liquid water solutions. The hydrogels that are appropriate for use in accordance with the claimed invention must have the following properties. The hydrogel must be extrudable or moldable to allow use in cable construction. The hydrogel must expand when exposed to an aqueous solution and the hydrogel must return to its original form after the hydrogel is dried, which may be due to water evaporation. In other words, the hydrogel must shrink back to substantially its original size, as measured by the ability to shrink sufficiently, in order to not prevent a change in impedance of the aqueous solution leak detection cable. In general terms, this may be on the order of 5%-10% of the amount that the hydrogel swelled during absorption of the aqueous solution. In addition, the hydrogel must swell in three dimensions.

Suitable hydrogel materials include sodium polyacrylate. Sodium polyacrylate can retain hundreds of times its own weight in water. Sodium polyacrylate (ACR, ASAP, or PAAS) is a sodium salt of polyacrylic acid. Sodium polyacrylate is a super absorbent polymer (SAP) and has the ability to absorb 100-1000 times its mass in water. Sodium polyacrylate is an anionic polyelectrolyte with negatively charged carboxylic groups in its main chain. It is a chemical polymer made up of chains of acrylate compounds. It contains sodium, which gives it the ability to absorb large amounts of water. Sodium polyacrylate has good mechanical stability, high heat resistance, and strong hydration. It has been used as an additive for food products including bread, juice, and ice cream. While sodium neutralized polyacrylic acids are the most common form used in industry, there are also other salts available, including potassium, lithium, and ammonium, which are also suitable materials for the present invention.

Another super absorbent polymer is hydrophilic TPE. Hydrophilic TPE provides a controlled expansion on contact with an aqueous liquid solution with a pH value between 7-12. Once the liquid evaporates, the swelling reduces back to the original shape and size. This process can be repeated many times with no detrimental effect on the performance of the material. Hydrophilic TPE contains small spherical polymer particles that are called nanoparticulate hydrophilic polymers (NHPs). These tiny particles, which measure between 500-1000 nanometers, are what gives the hydrophilic TPE many unique and highly desirable properties. These properties include controlled expansion, in which each particle expands in a controlled and integrated way to produce the necessary swelling. The particles are not ejected and remain within the material. Hydrophilic TPE has high mechanical strength. When enlarged, particle ejection is resisted, which could cause a fragile matrix. Hydrophilic TPE is also easy to apply. It does not need to be encapsulated, making it suitable for various concrete applications. The material is also recyclable and does not disintegrate under wet and dry cycles. For example, extrusion can be used to create a layer of hydrophilic TPE in an aqueous leak detection cable. Hydrophilic TPE can be easily extruded into various profiles. Hydrophilic TPE can expand to 1000% of its size upon absorption of water. Hydrophilic TPE is available from Reddiplex Ltd., headquartered at The Furlong, Berry Hill Industrial Estate, Droitwich, WR9 9BG, United Kingdom, and is sold under the trade name Reddiplex®.

Hydrophilic rubber, which is based on polychloroprene, can also be used as a hydrogel material in an aqueous solution leak detection cable. These hydrophilic rubber materials, based on polychloroprene, are available from TPH Bausysteme GmbH, headquartered at Nordportbogen 8, 22848 Norderstedt, Germany. These materials are sold by TPH Bausysteme GmbH under the trade name Hydrotite® and are described as a water-expandable rubber or neoprene based on a polychloroprene that is produced from chloroprene by radical emulsion polymerization. The expansion properties of these materials result from the irrevocable bonding of polyurethane-based water-expandable polymer resin with a CR-matrix by vulcanization. Hydrotite® can expand to 1300% of its volume when absorbing water. The CR-matrix provides strength of shape during the expanding process. Hydrotite® is typically used in sealing of construction joints, renovation of expansion joints, sealing of precast concrete component panels, tubbing segments in tunneling, the sealing of shaft rings and pipe lead-throughs, etc.

Another hydrogel material suitable for the presently claimed invention is sold under the trade name Dryflex® WS+, which is a hydrophilic TPE material available from HEXPOL AB, headquartered at Skeppsbron 3, SE-211 20 Malmö, Sweden. Dryflex® WS+ is a thermoplastic elastomer (TPE) which swells when in contact with an aqueous solution. Dryflex® WS+ was originally created to provide positive seals and prevent the ingress or exit of water in various applications. In accordance with the presently claimed invention, Dryflex® WS+ is extrudable and can be used as a hydrogel layer in an aqueous solution leak detection cable. When water is no longer present, the material shrinks back to its approximate original size. This process of expansion and contraction can be repeated multiple times since the materials have a solid structural integrity. Dryflex® WS+ can be injection molded. Deionized water can cause the Dryflex® WS+ to expand multiple percentage volumes over its original size. Dryflex® WS+ works in saline solutions. Dryflex® WS+ exhibits excellent retention of properties during repeated cycling over multiple years. The pH level of the aqueous solution has an effect on both the amount and rate of swell of the material. Multiple percentages of swell volume can be achieved, even at high pH and low pH levels.

Aqueous solutions may include various corrosive compounds that can shorten the life of the hydrogel material. Aqueous solutions that contain solvents that dissolve the carrier compound, such as TPE or rubber-based or plastic-based materials, may be less than ideal for using in a aqueous solution leak detection cable. A hydrophilic additive, such as sodium polyacrylate or other super absorbent polymers (SAP), are mixed with a carrier compound, such as TPE or an elastomer such as a thermoplastic or thermoset material. In general, interaction between elastomers and chemicals follows the rule that “like dissolves like.” For example, most polar polymers dissolve in polar solvents and rarely dissolve in non-polar solvents, and vice versa. In addition, the degree of swelling can be predicted using solubility parameters. If the sealed fluid has a solubility parameter close to that of the elastomer, the attraction will be high, resulting in swelling. The degree of swell decreases when the differential between the solubility of the elastomer and surrounding media increases. Examples of elastomers that can be combined with a hydrophilic additive, such as a superabsorbent polymer, include sodium polyacrylate, potassium polyacrylate, lithium polyacrylate, and ammonium polyacrylate.

A non-polar synthetic polymer ethylene-propylene rubber (EPM) and ethylene-propylene diene rubber (EPDM) are suitable for use with hot water and steam, break fluids, alkalis and acids, ketones in alcohols, and sunlight in ozone.

Nitrile rubber (NBR) is another example. The acrylonitrile content determines the elastomers fluid resistance. NBR is recommended for aliphatic and aeromatic hydrocarbons, oils, gasoline, greases, and hydraulic fluids.

HNBR is another example of a carrier for the hydrophilic additives that can be obtained by either partial or complete hydrogenation of acrylonitrile-butadiene rubber, which has a generic name of hydrogenated nitrile rubber (HNBR). HNBR is recommended for hot water and steam, oils, and fuels.

Fluoroelastomer rubber (FKM) is another example of a carrier material. The chemical resistance of FKM is determined by the fluorene content ranging from 65% to 70% and the type of monomer used. There are five distinct classes of FKM materials based on the types of monomers used and the polymerization process. It is recommended for aliphatic and aeromatic hydrocarbons, gasoline, gasoline/alcohol blends, and chlorinated solvents.

Fluorosilicone rubber (FVMQ) is a modified silicone rubber that has many attributes of silicone rubber but with improved chemical resistance. This material is recommended for dilute acids and alkalis, petroleum oils, and hydrocarbon fuels.

Perfluoroelastomers (FFKM), which are also referred to as an elastomeric version of PTFE, are the highest performance group of elastomers. These elastomers have a fully fluorinated backbone and the broadest possible chemical resistance. This is recommended for a broad range of chemicals that may be included in an aqueous solution.

Plastics can also function as carriers for hydrophilic additives. As indicated above, plastics can comprise thermoplastics or thermoset plastics. Plastics are generally more rigid than elastomers, but plastics can range from very ductile to brittle, and chemical resistance varies greatly. Examples of plastics include polytetrafluoroethylene (PTFE), which has resistance against virtually all media. There are only a few chemicals in extreme conditions that attack PTFE, including molten alkali metals, gaseous fluorene at high temperatures and pressures, and a few organic halogenated compounds. In addition, PTFE has a wide usable temperature range and low friction, making it a good carrier. PTFE has no elastic capabilities, however. PTFE can be used in conjunction with an elastomer energizer to increase elasticity. However, the elastomer energizer must be compatible with the aqueous solution chemicals used.

Polyetheretherketone (PEEK) excels in high temperature steam.

Ultra-high molecular-weight polyethylene (UHWPE) is extremely tough and has good friction and wear properties. It performs well in aqueous based fluids and most oils, but can be affected by some aggressive chemicals.

In general, hydrogel materials are capable of absorbing water, including non-ionic water, and swelling in three dimensions as a result of the absorption of the aqueous solution. These polymers absorb the aqueous solutions and swell which creates a reactive force on the non-expandable permeable cover 102 so that the forces created by the swelling are directed inwardly towards the conductive fabric braid 114.

The conductive fabric braid, illustrated in FIG. 1, can be made of a conductive polymer coated mesh, a conductive polymer doped with conductive materials, or any type of conductive material, such as graphite, carbon, carbon nano-particles, copper particles, silver particles, or other metal or conductive particles or nano-particles. A conductive fabric braid is a conductive covering that is placed over the feedback wire 122. Any desirable conductive covering can be used, such as a conductive fabric braid, a conductive tube, or other flexible covering. The covering can be applied by different techniques, including braiding, extrusion, etc.

The protective cover 116 can be any protective material that provides protection against punctures and is wear resistant. The protective cover 116 protects the non-expandable permeable cover 102 from punctures, wear, and other potential hazards.

The reusable reactive polymer 104 can be made of any of the aqueous solution reactive polymers described herein. The materials described above are just several examples of carriers and super absorbent polymers that can be used, and while the description provided herein refers to these materials, any suitable water reactive polymer and carrier can be used in place of these materials.

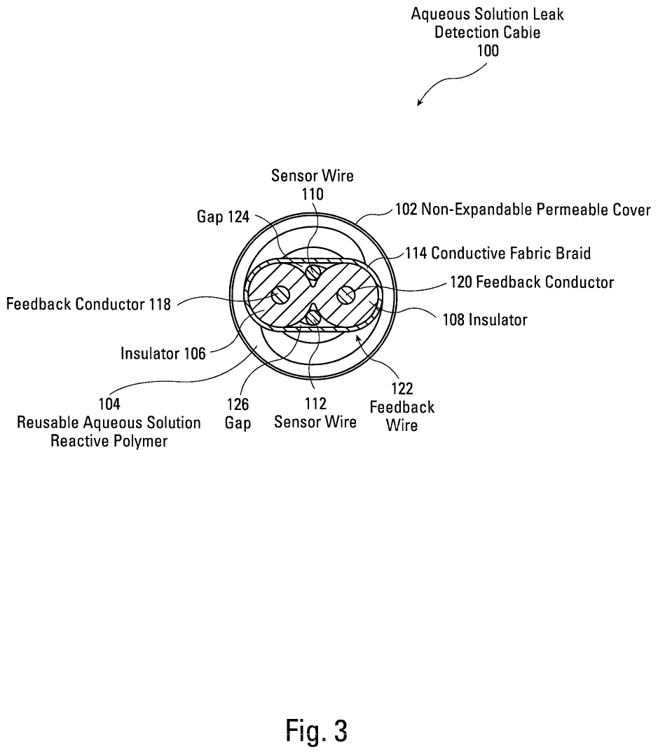

The non-expandable permeable cover 102 can be made of a Kevlar braid, or other tightly wound fabric braid, which has recesses that are permeable to aqueous solutions. Again, Kevlar braid is used as one example of a tightly wound fabric braid that has minimal or no expansion resulting from the pressures created by the aqueous solution reactive polymer. Feedback wire 122 has insulators 106, 108 which cover feedback conductors 118, 120, illustrated in FIG. 3. Sensor wires 110, 112 are placed in the intersections of insulators 106, 108, as illustrated in FIG. 3. The conductive fabric braid 114 is a fabric that is braided with conductors so that the conductive fabric braid 114 has conductance. The conductive fabric braid 114 has a sufficient amount of stiffness so that the conductive fabric braid 114 is not compliant with the feedback wire 122, as shown in more detail in FIG. 3. The conductive fabric braid can be made from conductive polymers, a mixture of conductive polymers and wires, or a nonconductive fabric braided with wires or conductive polymers.

The aqueous solution leak detection cable 100 may be placed in locations that are difficult to access in order to detect aqueous solution leaks. The aqueous solution leak detection cable 100 may be placed in various locations, such as under above ground tanks, under below ground tanks, under a pipeline that rests in sand, etc. The aqueous solution leak detection cable 100 may also be placed in a containment pipe of a double wall pipeline or transmission pipe, in a containment tank located under an underground tank and other locations that are difficult to access. It is therefore advantageous to be able to reuse the aqueous solution leak detection cable 100. In that regard, the aqueous solution leak detection cable 100 can be dried after an aqueous solution leak has been sealed or stopped so that the reusable reactive polymer 104 returns to its normal size prior to absorption of an aqueous solution. In that case, the reusable reactive polymer 104 should be made from a material that can return to its original size after being compressed. Many hydrogels are capable being compressed and then expanding to an original size after being compressed.

Alternatively, materials can be used that do not return to their normal size prior to absorption of aqueous solutions and as such, the cable can simply be replaced. In many applications, this simply requires cable pulling to replace the cable with a new cable. These types of cables may be less expensive to implement and may be more reliable since some materials simply do not return fully to their pre-expanded size. As such, the embodiments disclosed herein, as well as the claims may refer to the use of materials that may be either reusable or may not be reusable and require replacement. In many applications, the aqueous solution leak detection cable 100 may be laid out over a long distance to locate the position of any leak. For example, the aqueous solution leak detection cable 100 can be used to locate the position of a leak in a long pipeline. The present invention uses conductance to determine the location of a leak. Conductance allows the aqueous solution leak detection cable 100 to be laid out over miles, with the ability to detect the location of the leak within a few feet. Tens of miles of coverage can be obtained using one set of electronics. Of course, the detector electronics can be coupled wirelessly to a central facility that can alarm the operators of a pipeline to indicate a aqueous solution leak and the location of the aqueous solution leak. The cable can also be used on large underground tanks. In that regard, the aqueous solution leak detection cable 100 can be used to locate the position of the leak with regard to the tank so that the location of excavation around the tank can be determined for sealing leaks.

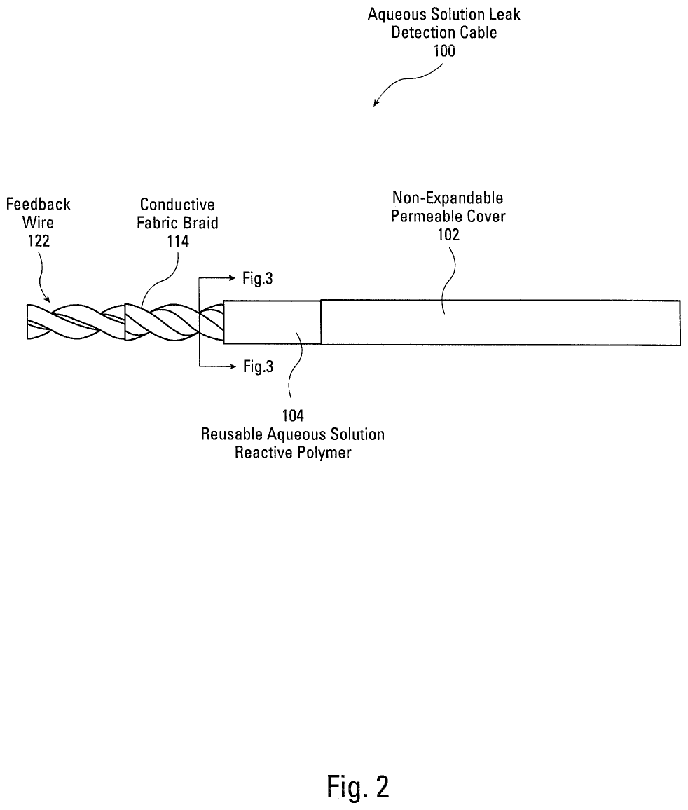

FIG. 2 is a side partial cut-away view of the leak detection cable 100 in FIG. 1. As illustrated in FIG. 2, the non-expandable permeable cover 102 covers the reusable reactive polymer 104. The reusable reactive polymer 104 covers the conductive fabric braid 114, which in turn covers the feedback wire 122.

FIG. 3 is a cross-sectional view of the aqueous solution leak detection cable 100 illustrated in FIGS. 1 and 2. As illustrated in FIG. 3, a non-expandable cover 102 covers the reusable aqueous solution reactive polymer 104. The non-expandable cover 102 may be a braided Kevlar that allows aqueous solution to pass through the recesses of the braided Kevlar. Similarly, the protective cover 116, illustrated in FIG. 1, is also permeable to aqueous fluid. The reusable aqueous solution reactive polymer 104 surrounds the conductive fabric braid 114. Located at the two intersections of insulator 106 and insulator 108 are sensor wire 110 and sensor wire 112. The sensor wires 110, 112 may be fused or bonded to the insulators 106, 108 so that the sensor wires 110, 112 do not move and contact the conductive fabric braid 114.

Feedback conductor 118 is centrally located in insulator 106, while feedback conductor 120 is centrally located in insulator 108. Insulators 106, 108 form a figure eight configuration in a cross-section, as shown in FIG. 3, which is a typical configuration for detector cables.

As further shown in FIG. 3, the conductive fabric braid 114 has sufficient structure and stiffness that gaps 124, 126 are created between sensor wire 110 and conductive fabric braid 114, and sensor wire 112 and conductive fabric braid 114, respectively.

In operation, aqueous fluid from a leak penetrates the non-expandable cover 102 and contact the reusable aqueous solution reactive polymer 104. The reusable aqueous solution reactive polymer 104 swells as the reusable aqueous solution reactive polymer 104 absorbs the aqueous solution. The non-expandable cover 102 does not allow the reusable aqueous solution reactive polymer 104 to expand in an outward direction, so that the expansion of the reusable aqueous solution reactive polymer 104 is directed inwardly towards the conductive fabric braid 114. The conductive fabric braid 114 deflects inwardly in response to the swelling of the reusable aqueous solution reactive polymer 104 and creates a conductive contact between the conductive fabric braid 114 and sensor wires 110 112. In this manner, a short is created between the sensor wires 110, 112. The sensor wires 110, 112 are resistive wires that have a slight resistance created by various means, such as alloys included in the wire, so that the wire has a specific resistance per unit of length. The sensor wires 110, 112 are connected to the feedback conductors 118, 120 at the end of the wire. For example, the aqueous solution leak detection cable 100 may extend for a distance of five miles between pumping stations in an aqueous solution pipeline, sewer line, etc. At the end of the five mile stretch, the sensor wire 110 is connected to the feedback conductor 118, and the sensor wire 112 is connected to the feedback conductor 120, or vice versa. By detecting the difference in current passing through the sensor wires 110, 112 to the feedback conductors 118, 120, respectively, when a short occurs, the distance to the short along the aqueous solution leak detection cable 100 can be determined as a result of the uniform and consistent resistance of the sensor wires 110, 112 per unit length. This allows the system to accurately determine the location of a aqueous solution leak as a result of a determination of the location of the short between sensor wires 110, 112, due to the conductive fabric braid 114 creating a short circuit.

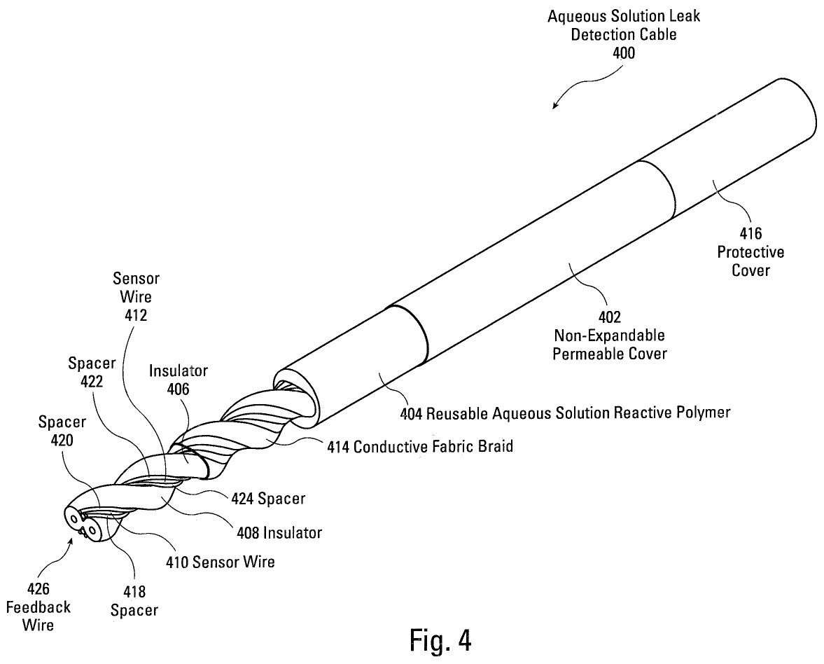

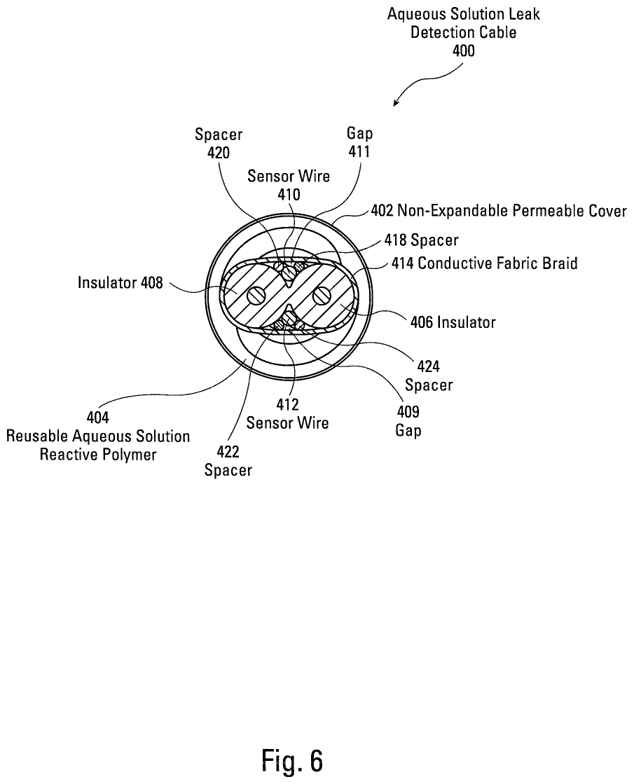

FIGS. 4-6 illustrate another embodiment of the present invention. As shown in FIG. 4, the aqueous solution leak detection cable 400 has a protective cover 416 similar to the protective cover 116 illustrated in FIG. 1. Protective cover 416 surrounds the non-expandable permeable cover 402. Again, the non-expandable permeable cover 402 can be constructed from various plastic monofilament fibers that do not expand or have very little expansion, and are braided in a manner that provides protection to the underlying layers, such as the reusable aqueous solution reactive polymer 404. The non-expandable permeable cover 402 has recesses through the braid that allow liquid and gas aqueous solution to seep through the non-expandable permeable cover 402 and penetrate the reusable aqueous solution reactive polymer 404. The reusable aqueous solution reactive polymer 404 swells as the reusable aqueous solution reactive polymer 404 absorbs aqueous solution. The moisture absorbent polymers absorb the aqueous solution liquid and swell which creates a reactive force on the non-expandable permeable cover 402 so that the forces created by the swelling are directed inwardly towards the conductive fabric braid 414 so that the non-expandable permeable cover 402 allows little or no expansion. As further shown in FIG. 4, sensor wires 410, 412 are tucked or placed between the insulator 406 and spacers 418, 420. This is more clearly shown in FIG. 6.

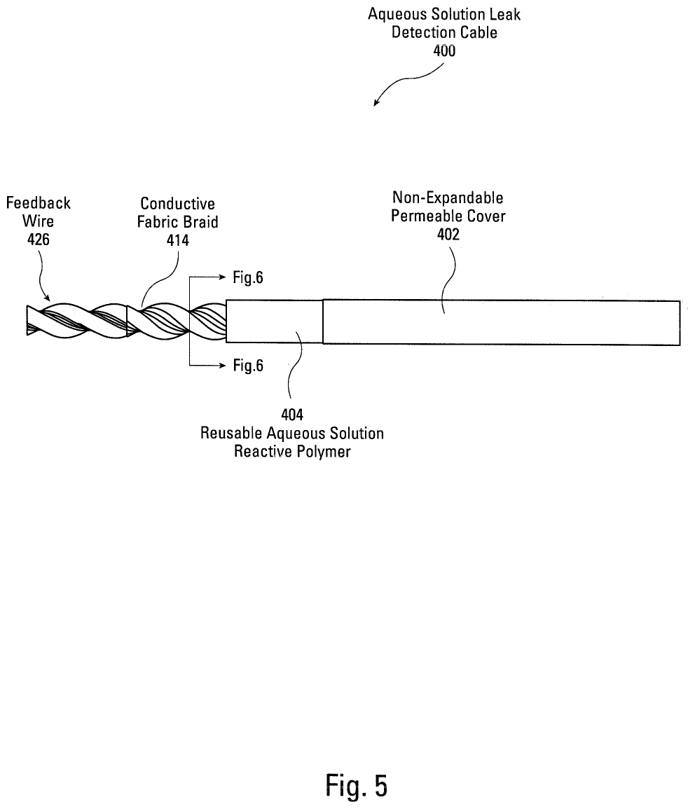

FIG. 5 is a side view of the aqueous solution leak detection cable 400. As illustrated in FIG. 5, the non-expandable permeable cover 402 covers the reusable aqueous solution reactive polymer 404. The reusable aqueous solution reactive polymer 404 is described above and covers the conductive fabric braid 414. A description of a conductive fabric braid 414 is also provided above. The conductive fabric braid 414 also covers the feedback wire 426.

FIG. 6 is a cross-sectional view of the aqueous solution leak detection cable 400 at the location indicated in FIG. 5. As illustrated in FIG. 6, a non-expandable permeable cover 402 covers the reusable aqueous solution reactive polymer 404. The reusable aqueous solution reactive polymer 404 fills the area between the non-expandable permeable cover 402 and the conductive fabric braid 414. Sensor wire 410 is placed against insulators 406, 408. Spacers 418, 420 are placed between the conductive fabric braid 414 and insulators 406, 408 so that spacers 418, 420 are located outwardly from sensor wire 410 and create a gap 411 between the sensor wire 410 and the conductive fabric braid 414. Similarly, spacers 422, 424 are located between the insulator 408, 406, respectively, and create a gap 409 between the conductive fabric braid 414 and sensor wire 412. Spacers 418, 420 may be bonded to the sensor wire 410 and/or bonded to insulators 406, 408, respectively. Similarly, spacers 422, 424 may be bonded to sensor wire 412 and/or insulators 408, 406 respectively. The spacers 418, 420, 422, 424 can be bonded using adhesives, through heat fusion, or any desirable method of maintaining the spacers 418-424 in place, especially during twisting of the aqueous solution leak detection cable 400.

In operation, liquids containing water permeate the non-expandable permeable cover 402 and the protective cover 416, illustrated in FIG. 4. Aqueous solution then penetrate the reusable aqueous solution reactive polymer 404, which absorbs the aqueous solution and swells. Outward swelling is contained by the non-expandable permeable cover 402 so that forces are created inwardly and the non-expandable permeable cover 402 expands inwardly to compress the conductive fabric braid 414. Spacers 418, 420 create a gap 411, which prevents accidental contact by the sensor wire 410 with the conductive fabric braid 414. As the reusable aqueous solution reactive polymer 404 expands in an inward direction, the conductive fabric braid 414 is pushed inwardly towards sensor wire 410 so that the conductive fabric braid 414 extends into the gap 411. Electrical contact then occurs between the sensor wire 410 and the conductive fabric braid 414. Similarly, the reusable aqueous solution reactive polymer 404 forces the conductive fabric braid 414 inwardly past spacers 422, 424 into gap 409 so that the conductive fabric braid 414 contacts sensor wire 412. The conductive fabric braid 414 consequently creates a short circuit between sensor wire 410 and sensor wire 412 at the location of the aqueous solution leak, which would cause the reusable aqueous solution reactive polymer 404 to expand. The location of the aqueous solution leak can then be determined using conduction techniques by sensing the change in current in the sensor wires 410, 412.

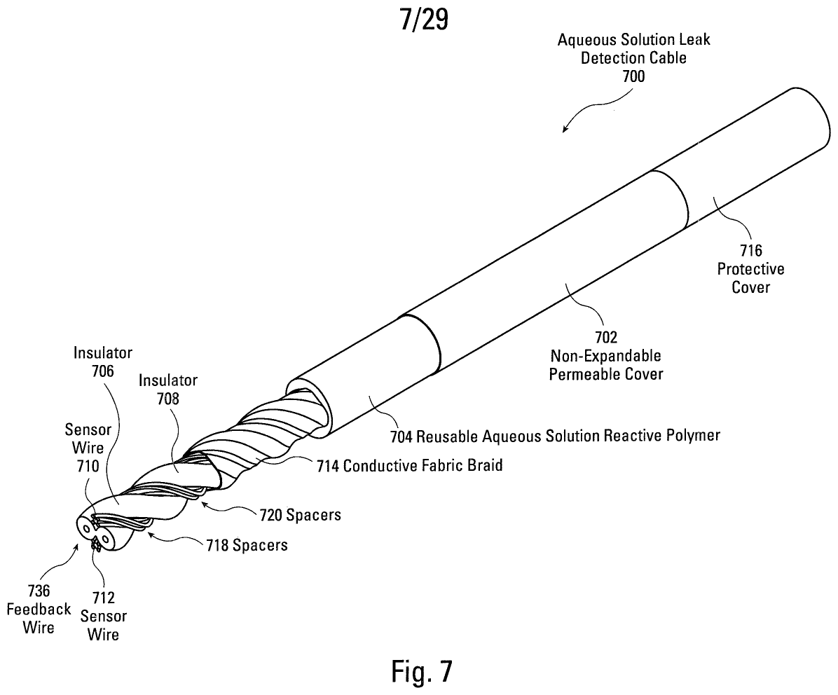

FIG. 7 is a schematic isometric view of another embodiment of a aqueous solution leak detection cable 700. As illustrated in FIG. 7, protective cover 716, which is permeable to aqueous solution, is placed over a non-expandable permeable cover 702. Non-expandable permeable cover 702 is also permeable to aqueous solution in the same manner as disclosed in the other embodiments. Non-expandable permeable cover 702 covers the reusable aqueous solution reactive polymer 704, which absorbs aqueous solution and swells as the reusable aqueous solution reactive polymer 704 absorbs aqueous solution. A conductive fabric braid 714 is placed over the feedback wire 736, which includes insulators 706, 708 and sensor wires 710, 712. The conductive fabric braid 714 also covers the spacers 718, 720.

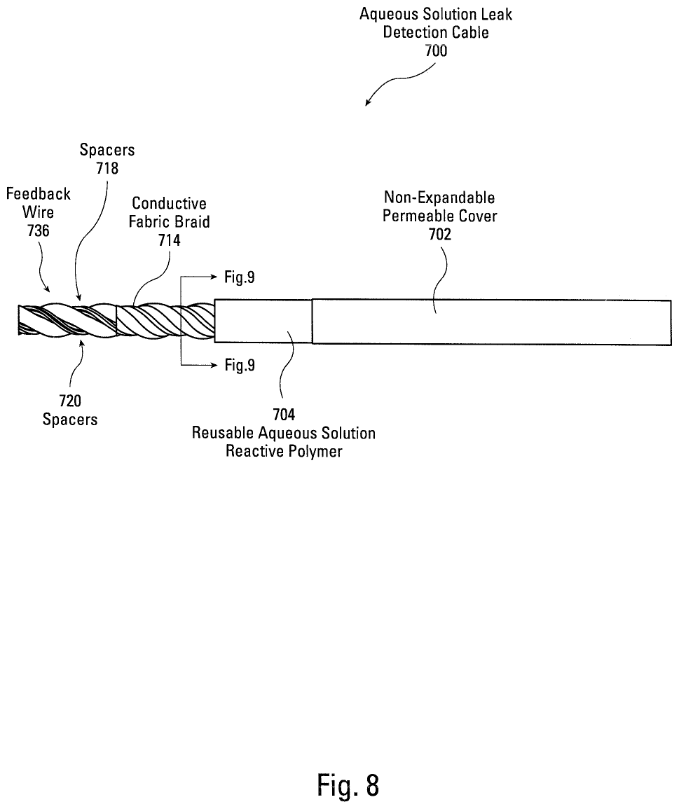

FIG. 8 is a side view of the aqueous solution leak detection cable 700. FIG. 8 discloses the non-expandable permeable cover 702, the reusable aqueous solution reactive polymer 704, the conductive fabric braid 714, spacers 718, spacers 720, and the feedback wire 736.

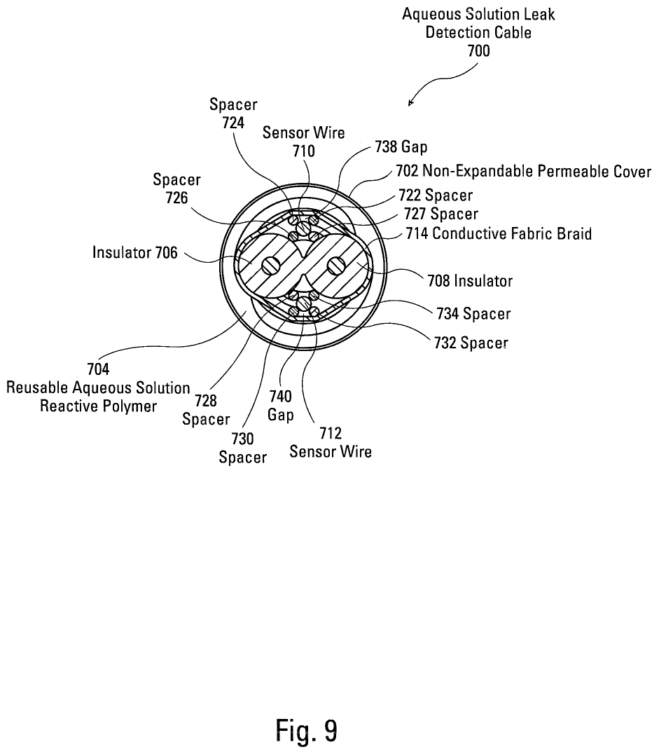

FIG. 9 is a cross-sectional view of the cross-section illustrated in FIG. 8. As shown in FIG. 9, the non-expandable permeable cover 702 covers the reusable aqueous solution reactive polymer 704. A conductive fabric braid 714 is covered by the reusable aqueous solution reactive polymer 704. The conductive fabric braid 714 surrounds the spacers 722, 724, 730, and 732. Spacers 726, 727, 724, 722, surround the sensor wire 710. Spacers 726, 727, 722, 724 may be braided around the sensor wire 710 so that the spacers stay in place around the sensor wire 710. Similarly, spacers 728, 730, 732, 734 may be braided around sensor wire 712 to maintain the position of the spacers around sensor wire 712. Otherwise, bonding can be used to secure the spacers to the sensor wire. Spacers 722, 724 create a gap 738 between the conductive fabric braid 714 and sensor wire 710. Similarly, spacers 730, 732 create a gap 740 between sensor wire 712 and the conductive fabric braid 714.

In operation, when aqueous solution leak, the aqueous solution penetrate the non-expandable permeable cover 702 and are absorbed by the reusable aqueous solution reactive polymer 704 as shown in FIG. 9. As a reusable aqueous solution reactive polymer 704 expands inwardly, the conductive fabric braid 714 is pushed inwardly and forces the conductive fabric braid 714 to contact the sensor wire 710. Similarly, the reusable aqueous solution reactive polymer 704 forces the conductive fabric braid 714 inwardly until it contacts sensor wire 712. In that fashion, a short circuit is created between sensor wire 710 and sensor wire 712. The location of the short circuit is determined by sensing the change in current on the sensor wires 710, 712.

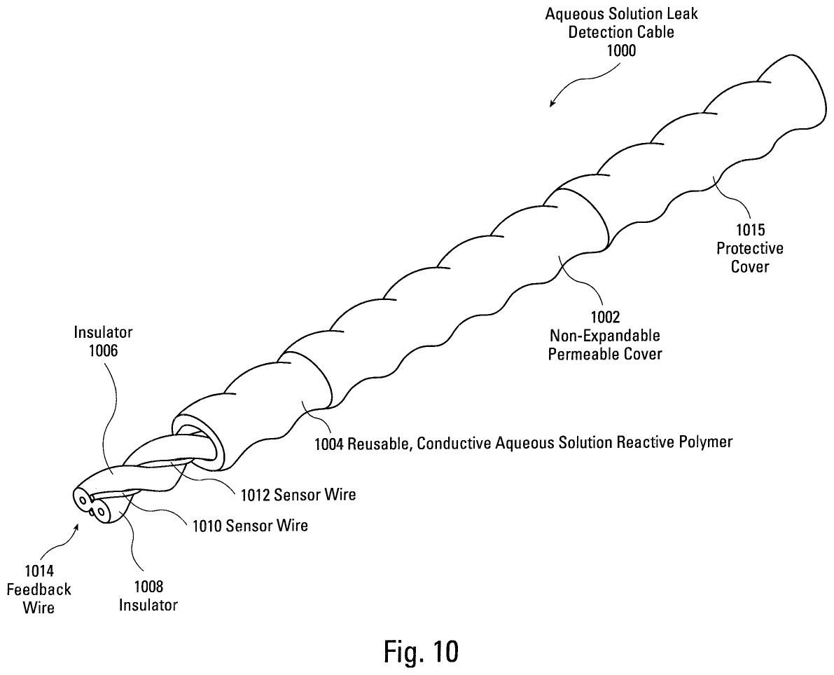

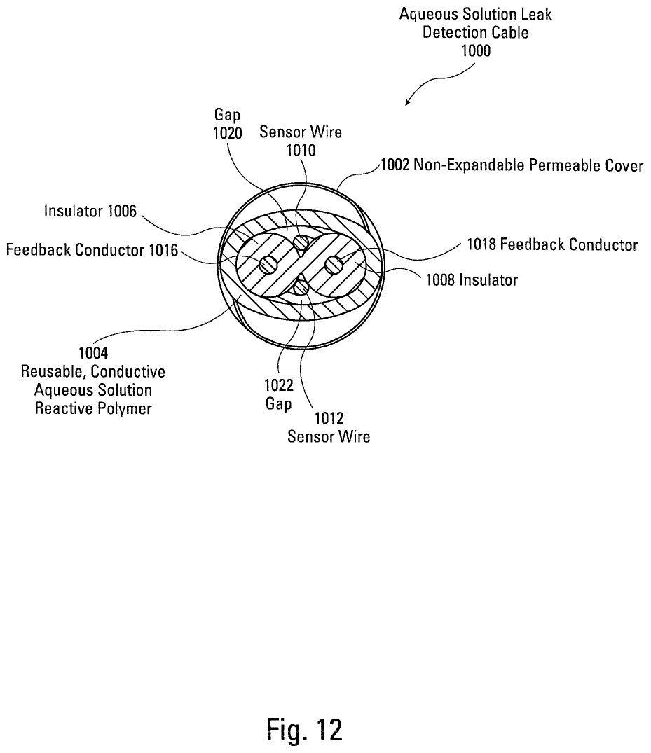

FIG. 10 is an isometric view of another embodiment of aqueous solution leak detection 1000. As illustrated in FIG. 10, a protective cover 1015 surrounds a non-expandable permeable cover 1002. Both the protective over 1015 and the non-expandable permeable cover 1002 allow aqueous solution to permeate. A non-expandable permeable cover 1002 surrounds the reusable, conductive aqueous solution reactive polymer 1004, which absorbs aqueous solution and swells. The non-expandable permeable cover 1002 substantially prevents outward expansion so the reusable, conductive aqueous solution reactive polymer 1004 swells inwardly. The reusable, conductive aqueous solution reactive polymer 1004 surrounds feedback wire 1014, which includes insulators 1006, 1008. Sensor wires 1010, 1012 are placed in the intersection of the insulators 1006, 1008, as more clearly illustrated in FIG. 12.

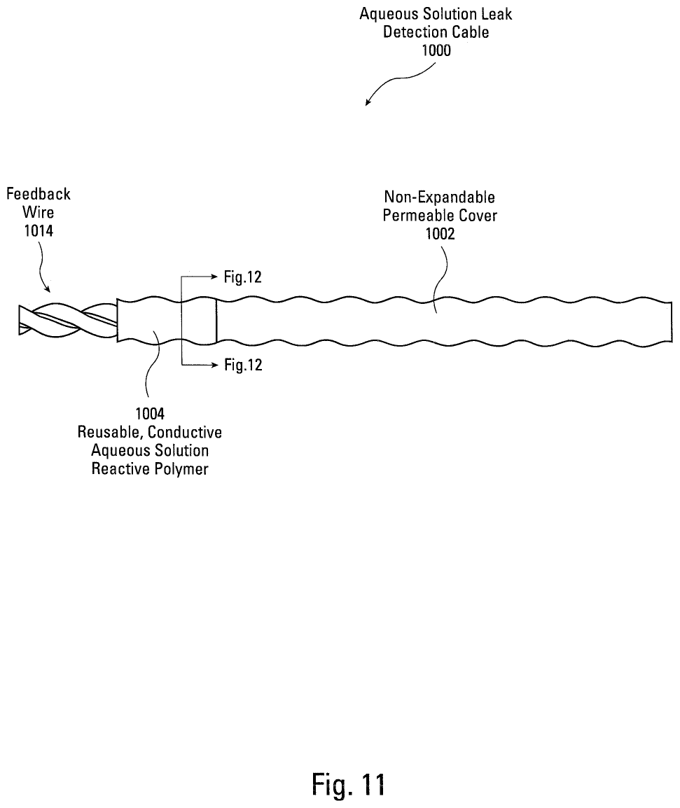

FIG. 11 is a side view of the aqueous solution leak detection cable 1000, as illustrated in FIG. 10. As illustrated in FIG. 11, the aqueous solution leak detection cable 1000 includes a non-expandable permeable cover 1002, a reusable, conductive aqueous solution reactive polymer 1004, and a feedback wire 1014.

FIG. 12 is a cross-sectional view of the aqueous solution leak detection cable 1000 at the location indicated in FIG. 11. As illustrated in FIG. 12, the non-expandable permeable cover 1002 covers the reusable, conductive aqueous solution reactive polymer 1004. The reusable, conductive aqueous solution reactive polymer 1004 may comprise a super absorbent polymer (hydrophilic additive) placed in a carrier such as a TPE compound or other carriers described above that has elasticity that also includes conductive particles, such as carbon particles, including carbon nanotubes. Other conductive particles can be used to dope the reusable, conductive aqueous solution reactive polymer 1004 to make it conductive, including metal particles. The reusable, conductive aqueous solution reactive polymer 1004 surrounds insulator 1006, 1008 and sensor wires 1010, 1012. As a result of the shape of the reusable, conductive aqueous solution reactive polymer 1004, gaps 1020, 1022 are created between the reusable, conductive aqueous solution reactive polymer 1004 and sensor wires 1010, 1012. Feedback conductors 1016, 1018 are disposed in insulators 1006, 1008, respectively.

In operation, when a aqueous solution liquid penetrates the non-expandable permeable cover 1002, the aqueous solution is absorbed by the reusable, conductive aqueous solution reactive polymer 1004, which swells and is contained by the non-expandable permeable cover 1002. As such, reusable, conductive aqueous solution reactive polymer 1004 expands inwardly and touches the sensor wires 1010, 1012, creating a short circuit. The location of the short circuit and, consequently, the location of the aqueous solution leak, is determined by the amount of current flowing through sensor wires 1010, 1012, as explained in more detail above.

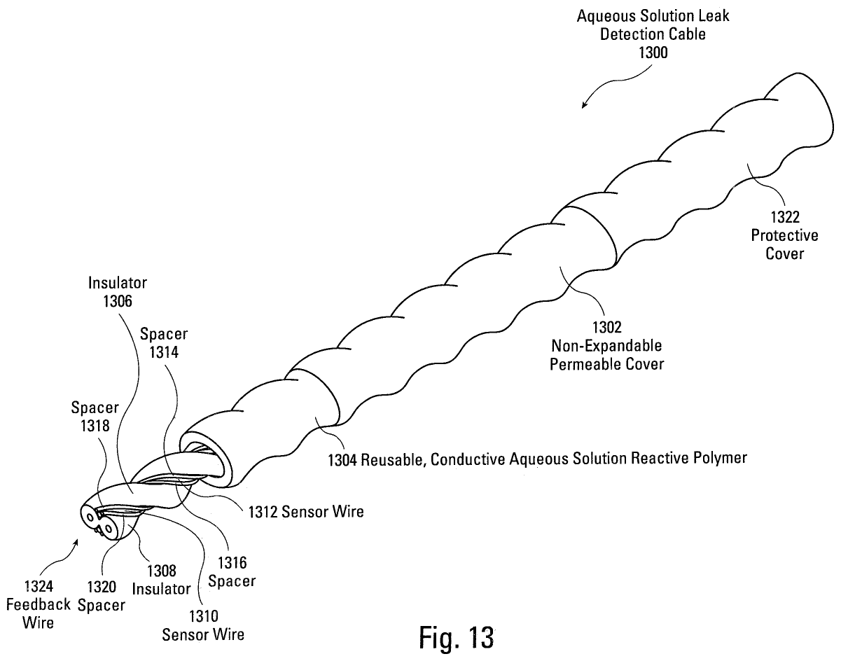

FIG. 13 is an isometric cutaway view of another embodiment of the aqueous solution leak detection cable 1300. As illustrated in FIG. 13, protective cover 1322 protects the non-expandable permeable cover 1302 and allows the aqueous solution to penetrate the protective cover 1322. The non-expandable permeable cover 1302 also allows the aqueous solution to pass through to the reusable, conductive aqueous solution reactive polymer 1304. The reusable, conductive aqueous solution reactive polymer 1304 absorbs the aqueous solution liquids and swells in an inward direction. The reusable, conductive aqueous solution reactive polymer 1304 surrounds a feedback wire 1324, which includes insulators 1306, 1308. The reusable, conductive aqueous solution reactive polymer 1304 also surrounds spacers 1314, 1316 and sensor wire 1312, as well as spacers 1318, 1320 and sensor wire 1310.

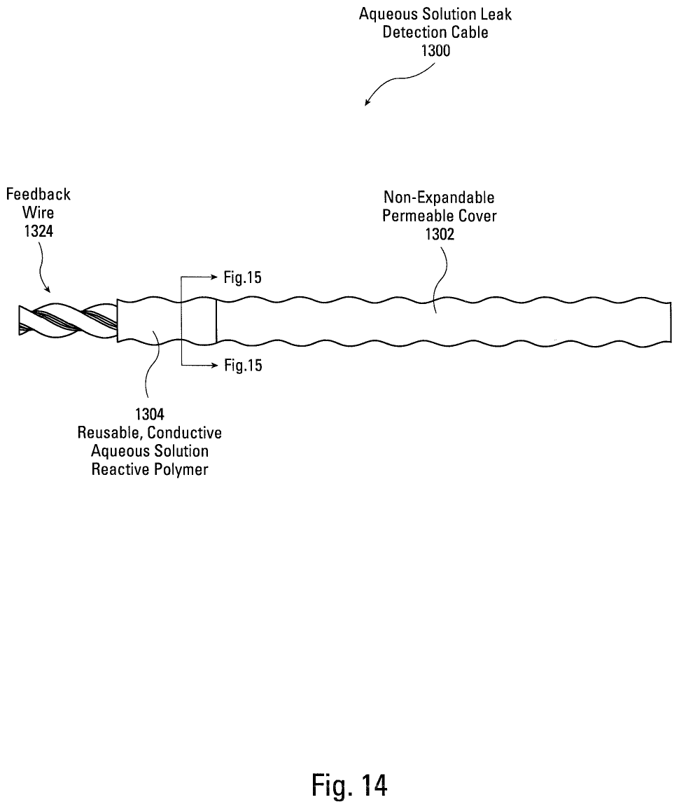

FIG. 14 is a schematic cutaway, side view of the aqueous solution leak detection cable 1300. As illustrated in FIG. 14, the non-expandable permeable cover 1302 is shown as surrounding the reusable, conductive aqueous solution reactive polymer 1304. These layers cover the feedback wire 1324.

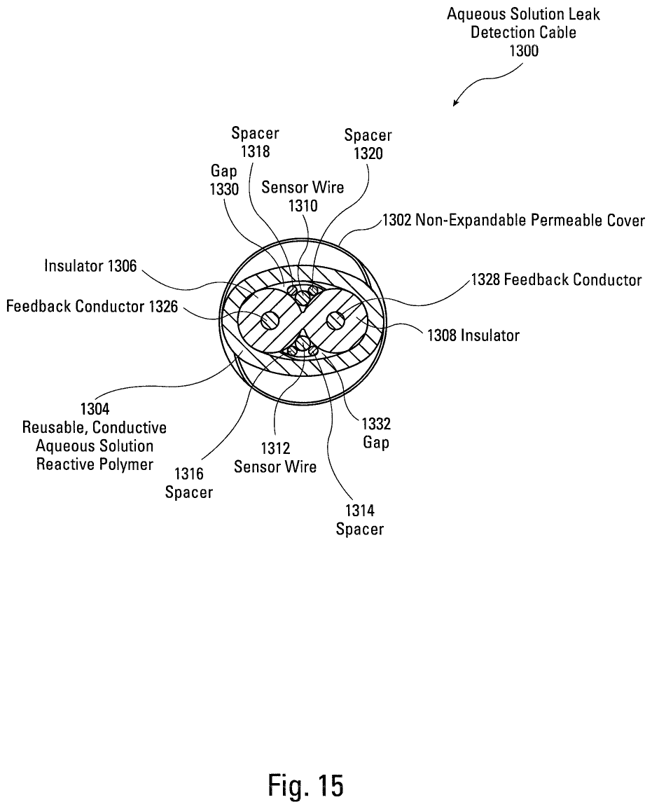

FIG. 15 is a cross-sectional view at the location indicated in FIG. 14. As illustrated in FIG. 15, the non-expandable permeable cover 1302 surrounds the reusable, conductive aqueous solution reactive polymer 1304. The reusable, conductive aqueous solution reactive polymer 1304 has a shape that surrounds the insulator 1306 and insulator 1308, as well as spacers 1318, 1320 and sensor wire 1310. The reusable, conductive aqueous solution reactive polymer 1304 also surrounds spacers 1316, 1314 and sensor wire 1312. The shape of the reusable, conductive aqueous solution reactive polymer 1304 creates a gap 1330 between the sensor wire 1310 and the reusable, conductive aqueous solution reactive polymer 1304. In addition, a gap 1332 is created by the shape of the reusable, conductive aqueous solution reactive polymer 1304 between the sensor wire 1312 and the reusable, conductive aqueous solution reactive polymer 1304. Feedback conductors 1326, 1328 are disposed in insulators 1306, 1308, respectively.

In operation, the reusable, conductive aqueous solution reactive polymer 1304 absorbs aqueous solution that pass through the non-expandable permeable cover 1302 and swells in an inward direction. The swelling causes the reusable, conductive aqueous solution reactive polymer 1304 to penetrate the gap 1330 and creates an electrical connection with the sensor wire 1310. Similarly, the reusable, conductive aqueous solution reactive polymer 1304 fills gap 1332 and creates an electrical connection with the sensor wire 1312. In this manner, the reusable, conductive aqueous solution reactive polymer 1304 causes a short circuit between sensor wire 1310 and sensor wire 1312 at the location where the reusable, conductive aqueous solution reactive polymer 1304 absorbs a aqueous solution liquid and swells.

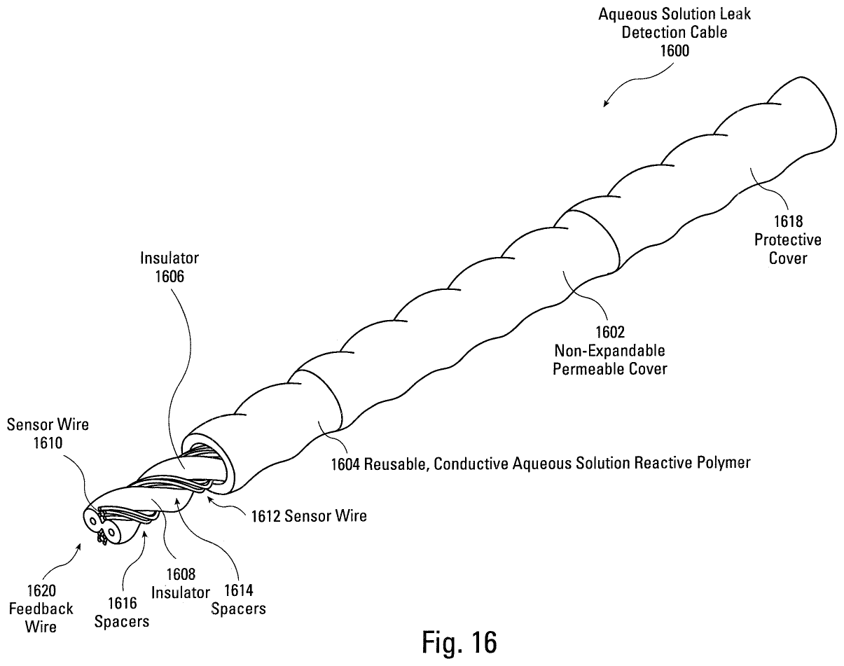

FIG. 16 is an isometric cutaway version of another embodiment of the aqueous solution leak detection cable 1600. The aqueous solution leak detection cable 1600 has a protective cover 1618 that covers the non-expandable permeable cover 1602. Again, the protective cover 1618 provides protection against abrasions, punctures, and other wear of the non-expandable permeable cover 1602. Non-expandable permeable cover 1602 is made of the same materials as the other non-expandable permeable covers disclosed above, such as Santoprene. The non-expandable permeable cover 1602 is permeable to liquid and gas aqueous solution so that the liquid and gas aqueous solution pass through the non-expandable permeable cover 1602 and penetrate the reusable, conductive aqueous solution reactive polymer 1604, which absorbs the aqueous solution and swells. Since the non-expandable permeable cover 1602 allows little to no expansion, the reusable, conductive aqueous solution reactive polymer 1604 swells in an inward direction towards sensor wire 1610 and sensor wire 1612, and moves between spacers 1614, 1616.

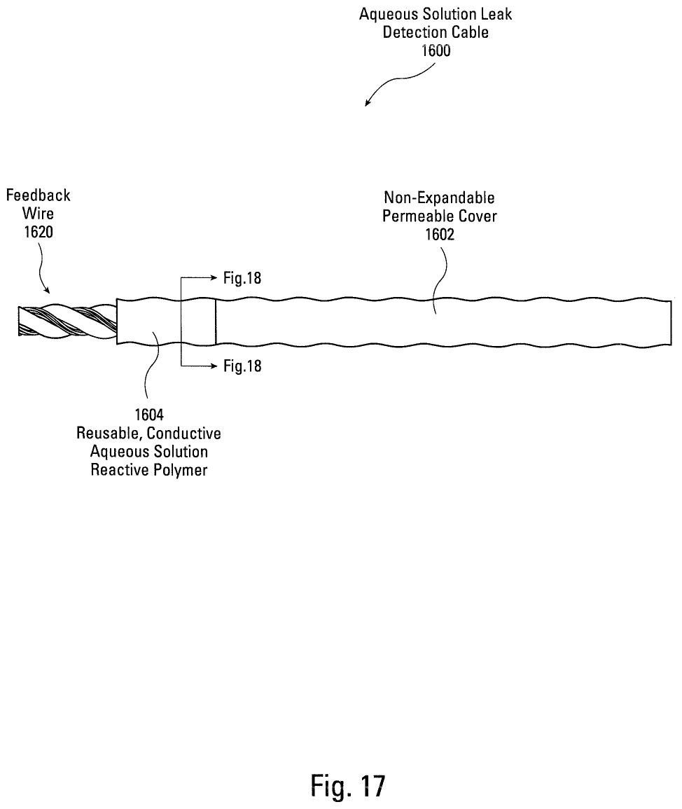

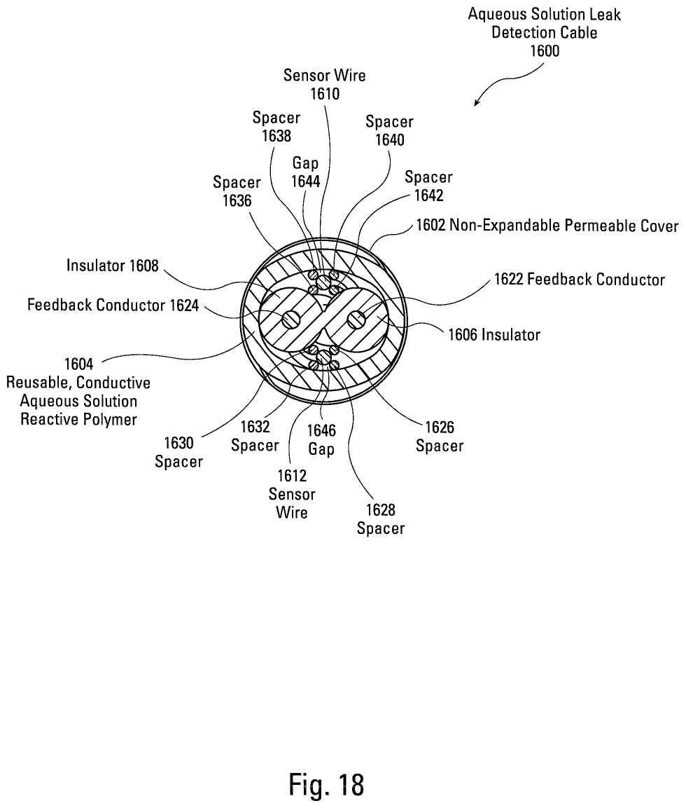

FIG. 17 is a side cutaway view of the aqueous solution leak detection cable 1600. As illustrated in FIG. 17, the non-expandable permeable cover 1602 covers the reusable, conductive aqueous solution reactive polymer 1604, which in turn covers the feedback wire 1620. A cross-section of FIG. 17 is indicated in FIG. 17, which is illustrated in FIG. 18. The protective cover 1618 is not shown in FIGS. 17 and 18 for simplicity.

FIG. 18 is a cross-sectional view of the aqueous solution leak detection cable 1600 at the location shown in FIG. 17. As illustrated in FIG. 18, the non-expandable permeable cover 1602 surrounds the reusable, conductive aqueous solution reactive polymer 1604. The reusable, conductive aqueous solution reactive polymer 1604 has an oval shape and is placed over the internal components of the aqueous solution leak detection cable 1600. The reusable, conductive aqueous solution reactive polymer 1604 can be placed over the internal portions of the aqueous solution leak detection cable 1600 using various methods, including extrusion. The extruder can shape the reusable, conductive aqueous solution reactive polymer 1604 so that it has the oval shape shown in FIG. 18. The feedback wire 1620 (FIG. 17) includes feedback conductor 1622, 1624 and insulators 1606, 1608. Sensor wire 1610 is surrounded by spacers 1636, 1638, 1640, 1642. Spacers 1636-1642 are braided around the sensor wire 1610 and then the braided sensor wire 1610 is placed in the recess between the insulators 1606, 1608. Similarly, sensor wire 1612 is surrounded by spacers 1626, 1628, 1630, and 1632, which are braided around the sensor wire 1612. The braided sensor wire 1612 is then placed in the other recess between insulators 1606, 1608. Other methods can be used for placing the spacers around the sensor wire such as by fusion or bonding.

In operation, when there is a aqueous solution leak, liquid and gas aqueous solution penetrate the protective cover 1618 and the non-expandable permeable cover 1602, and are absorbed by the reusable, conductive aqueous solution reactive polymer 1604. The reusable, conductive aqueous solution reactive polymer 1604 swells and expands as it absorbs the liquid and gas aqueous solution. The non-expandable permeable cover 1602 does not allow the reusable, conductive aqueous solution reactive polymer 1604 to expand outwardly so that the reusable, conductive aqueous solution reactive polymer 1604 expands inwardly into gap 1644 and gap 1646. When a conductive connection between the reusable, conductive aqueous solution reactive polymer 1604 is made between sensor wire 1610 and sensor wire 1612, a short circuit is created. The location of the short circuit and, consequently, the location of the aqueous solution leak, is determined by detecting the change in flow of current and the amount of change in the flow of current, as described above.

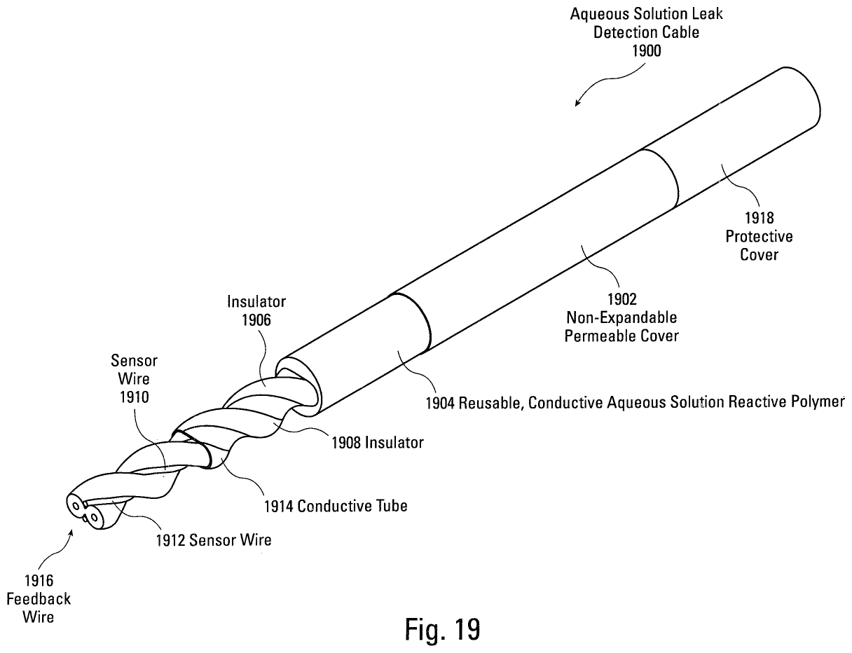

FIG. 19 is an isometric cutaway view of another embodiment of a aqueous solution leak detection cable 1900. As shown in FIG. 19, a protective cover 1918 covers a non-expandable permeable cover 1902. The protective cover 1918 and the non-expandable permeable cover 1902 are the same as the covers disclosed above. The non-expandable permeable cover 1902 covers the reusable, conductive aqueous solution reactive polymer 1904. The reusable, conductive aqueous solution reactive polymer 1904 covers the feedback wire 1916, which includes insulators 1906, 1908, conductive tube 1914, and sensor wires 1910, 1912.

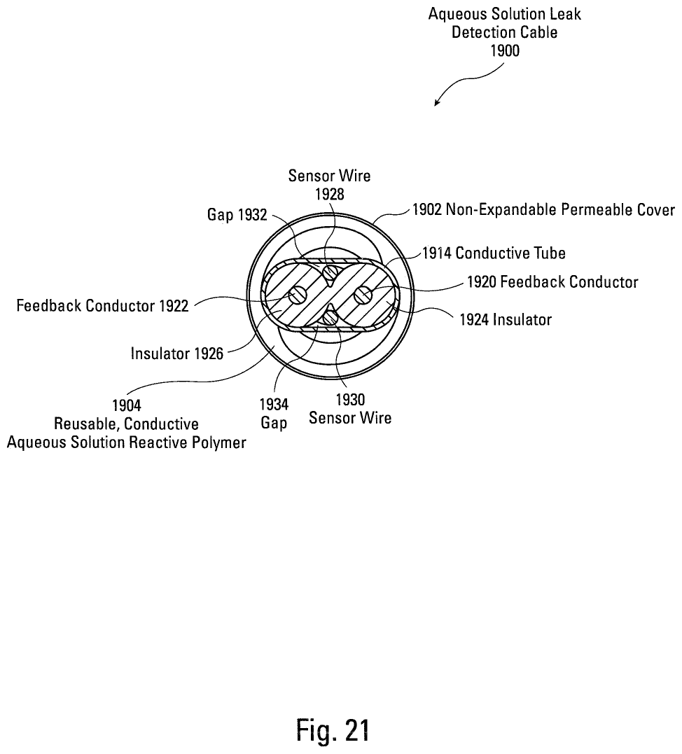

Conductive tube 1914 is a tubular material that is extruded or placed in the aqueous solution leak detection cable 1900 by other methods. The conductive tube 1914 is made from materials and has a thickness that provides a sufficient degree of stiffness so that the conductive tube 1914 does not accidentally touch sensor wires 1928, 1930, as illustrated in FIG. 21, unless there is pressure exerted on the conductive tube 1914 by the reusable, conductive aqueous solution reactive polymer 1904. These materials may comprise nitrile, Santoprene, thermoplastic vulcanizate (TPV), polyurethane, thermoplastic polyurethane (TPU), ethylene vinyl acetate (EVA), etc., having a thickness which varies according to the percentage of swelling that occurs when absorbing aqueous solution.

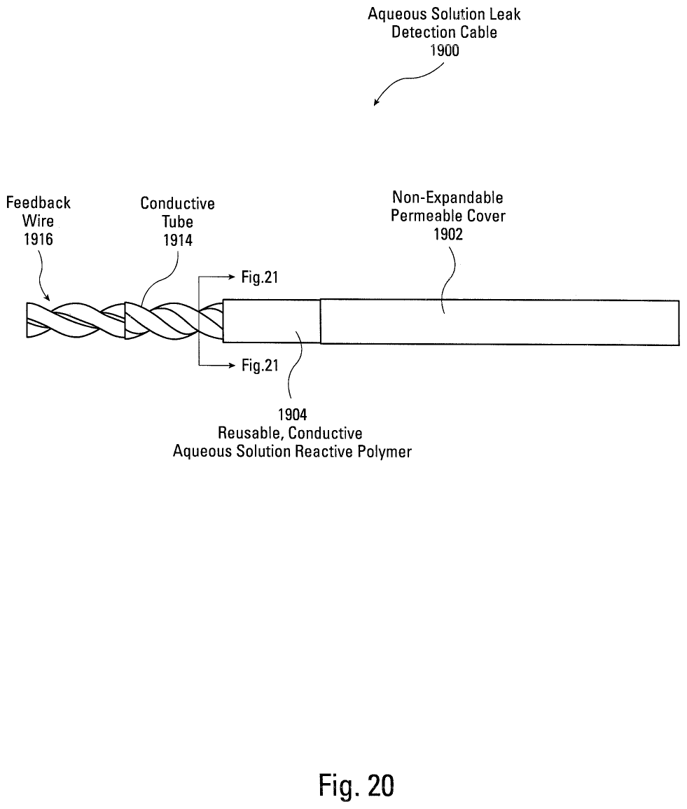

FIG. 20 is a side cutaway view of the aqueous solution leak detection cable 1900. As illustrated in FIG. 20, the non-expandable permeable cover 1902 covers the reusable, conductive aqueous solution reactive polymer 1904. The reusable, conductive aqueous solution reactive polymer 1904 covers the conductive tube 1914. FIG. 20 shows a cross-section which is illustrated in FIG. 21.

FIG. 21 is a cross-sectional view of the aqueous solution leak detection cable 1900. The location of the cross-section is illustrated in FIG. 20. As illustrated in FIG. 21, the non-expandable permeable cover 1902 covers the reusable, conductive aqueous solution reactive polymer 1904. A conductive tube 1914 surrounds the insulators 1926, 1924 as well as sensor wires 1928, 1930. A gap 1932 is created between sensor wire 1928 and conductive tube 1914. Similarly, a gap 1934 is created between sensor wire 1930 and conductive tube 1914.

In operation, aqueous solution penetrate the protective cover 1918 and the non-expandable permeable cover 1902, and are absorbed by the reusable, conductive aqueous solution reactive polymer 1904. When the reusable, conductive aqueous solution reactive polymer 1904 swells, it causes the conductive tube 1914 to move inwardly and contact sensor wires 1928, 1930, causing a short circuit. The location of the short circuit and the location of the aqueous solution leak can be determined by changes in current from feedback conductors 1920, 1922, since the sensor wires 1928, 1930 are resistive wires.

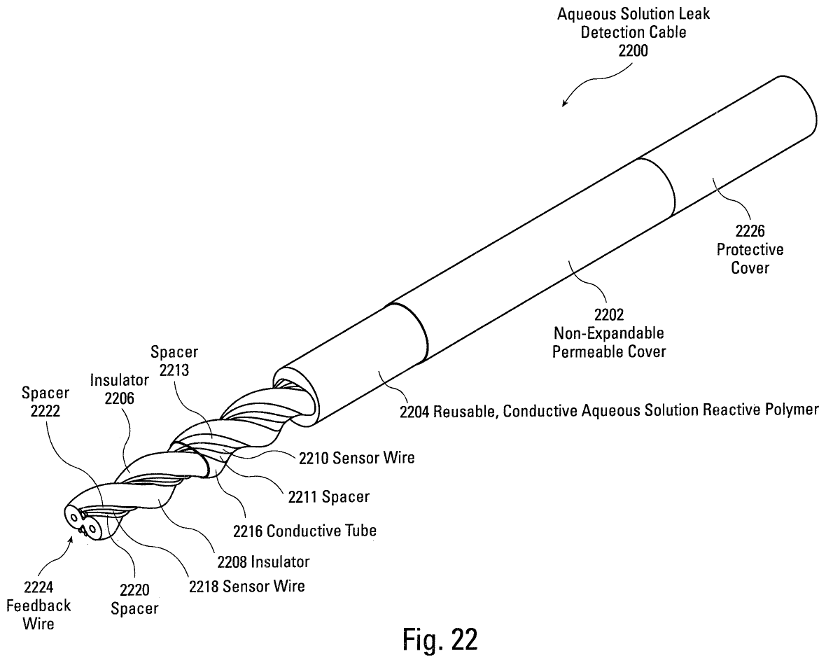

FIG. 22 is an isometric cutaway view of another embodiment of a aqueous solution leak detection cable 2200. As illustrated in FIG. 22, protective cover 2226 covers the non-expandable permeable cover 2202 and protects the non-expandable permeable cover 2202 from abrasions, punctures, and other wear. The non-expandable permeable cover 2202 surrounds the reusable, conductive aqueous solution reactive polymer 2204. The reusable, conductive aqueous solution reactive polymer 2204 expands in the presence of liquid and gas aqueous solution and is hydrophobic so that it does not absorb or expand in the presence of moisture or aqueous solution. Feedback wire 2224 includes insulators 2206, 2208. Spacers 2211, 2213, 2220, 2222, as well as sensor wires 2210, 2218 are placed in the recesses between the insulators 2206, 2208.

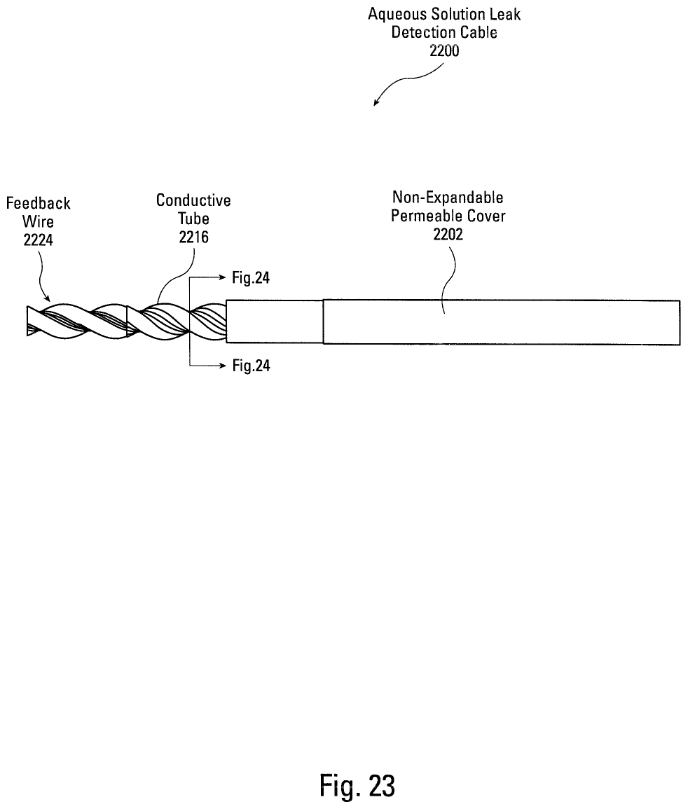

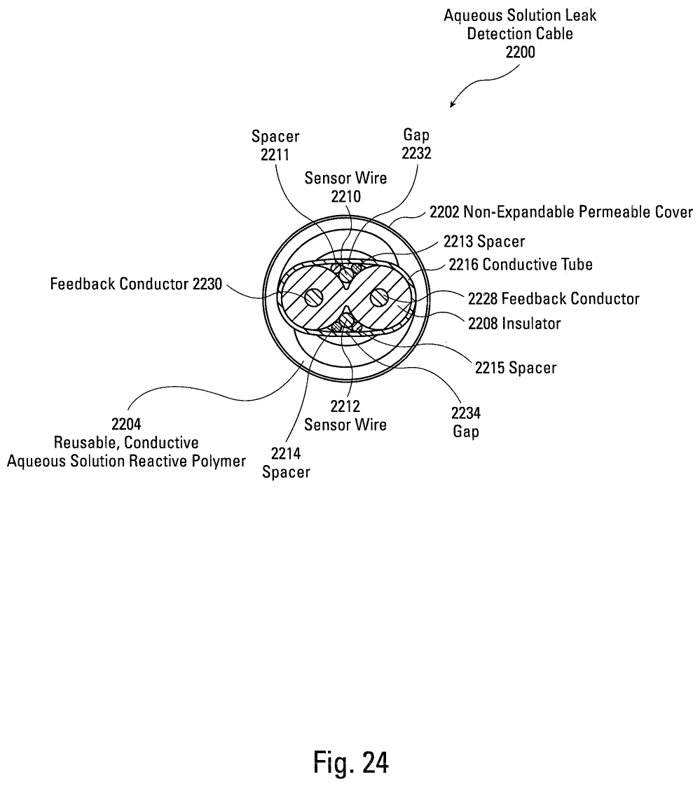

FIG. 23 is a side cutaway view of the aqueous solution leak detection cable 2200 illustrated in FIG. 22. FIG. 23 discloses the non-expandable permeable cover 2202, the conductive tube 2216, and the feedback wire 2224. FIG. 23 also discloses the location of the cross-section illustrated in FIG. 24.

FIG. 24 is a cross-sectional view of the aqueous solution leak detection cable 2200 at the location shown in FIG. 23. As illustrated in FIG. 24, the non-expandable permeable cover 2202 covers the reusable, conductive aqueous solution reactive polymer 2204. The protective cover 2226 is not illustrated in FIGS. 23 and 24. As shown in FIG. 24, the reusable, conductive aqueous solution reactive polymer 2204 surrounds the conductive tube 2216. The conductive tube 2216 surrounds the insulators 2206, 2208, sensor wires 2210, 2212, and spacers 2211, 2213, 2214, and 2215. Spacers 2211, 2213 create a gap 2232 between the sensor wire 2210 and the conductive tube 2216. Similarly, spacers 2214, 2215 create a gap 2234 between the sensor wire 2212 and conductive tube 2216.

In operation, liquid and gas aqueous solution penetrate the non-expandable permeable cover 2202 and are absorbed by the reusable, conductive aqueous solution reactive polymer 2204. As the reusable, conductive aqueous solution reactive polymer 2204 expands, it pushes the conductive tube 2216 into the gaps 2232, 2234 to create a conductive circuit (short circuit) between the sensor wire 2210 and sensor wire 2212. The location of the short circuit between the sensor wires provides the location of the aqueous solution leak by detecting a change in current on feedback conductors 2228, 2230.

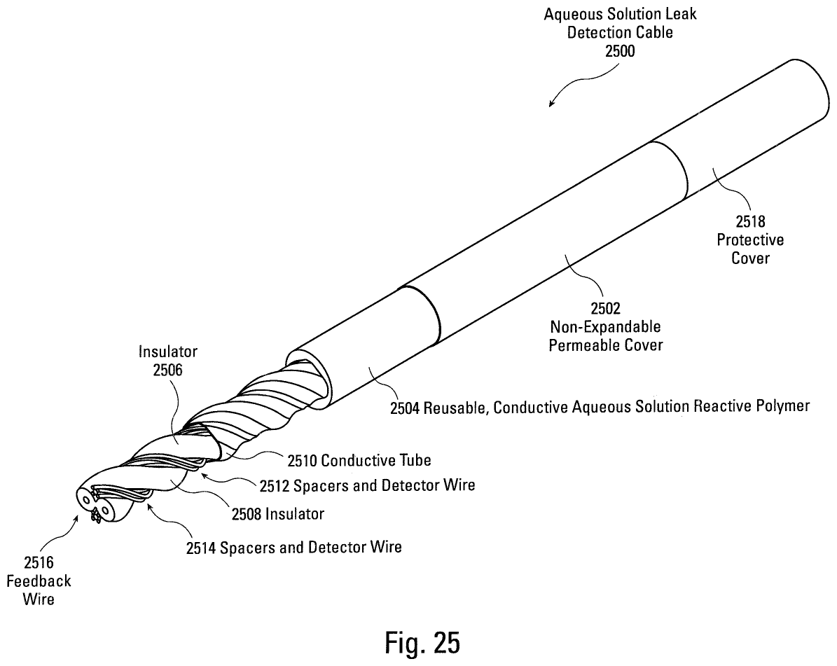

FIG. 25 is an isometric cutaway depiction of another embodiment of a aqueous solution leak detection cable 2500. As illustrated in FIG. 25, a protective cover 2518 provides protection for a non-expandable permeable cover 2502. Protective cover 2518 is permeable to aqueous solution and protects the non-expandable permeable cover 2502 from abrasions, punctures, and other wear. The non-expandable permeable cover 2502 covers reusable, conductive aqueous solution reactive polymer 2504. The reusable, conductive aqueous solution reactive polymer 2504 absorbs aqueous solution and expands as it absorbs the aqueous solution. The reusable, conductive aqueous solution reactive polymer 2504 surrounds a conductive tube 2510. The conductive tube 2510 surrounds the feedback wire 2516, which includes insulators 2506, 2508. Spacers and detector wires 2512, 2514 are placed in the recesses between the insulators 2506, 2508.

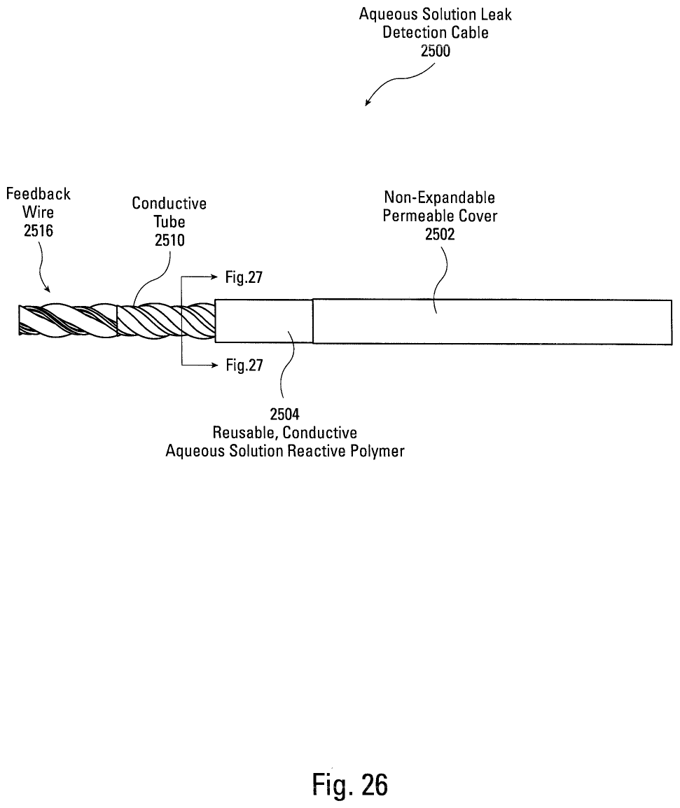

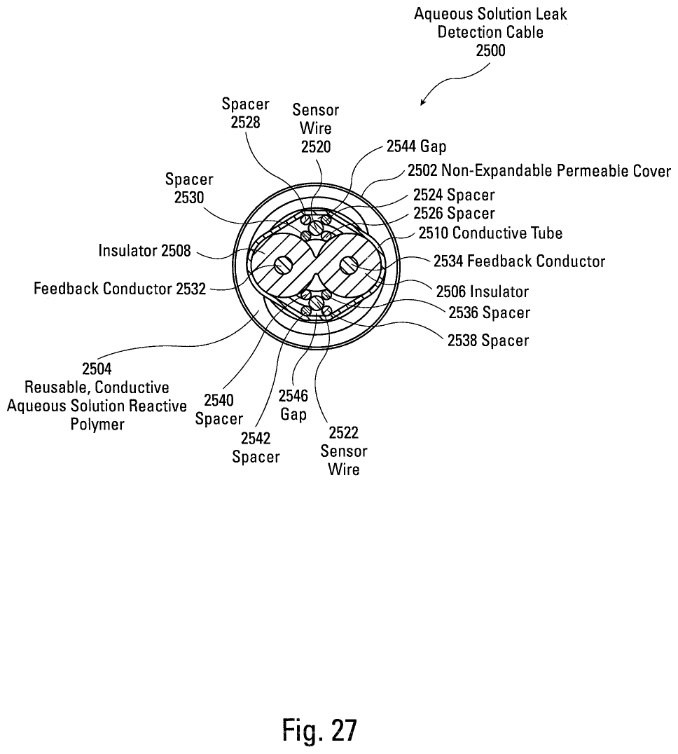

FIG. 26 is a schematic side cutaway view of the aqueous solution leak detection cable 2500. As shown in FIG. 26, the non-expandable permeable cover 2502 covers the reusable, conductive aqueous solution reactive polymer 2504. The protective cover 2518 is not illustrated in either FIG. 26 or 27 for the purposes of simplicity. Feedback wire 2516 is surrounded by the conductive tube 2510. A cross-section is shown in FIG. 26 which is illustrated in FIG. 27.

FIG. 27 is a cross-section of the aqueous solution leak detection cable 2500. As illustrated in FIG. 27, the non-expandable permeable cover 2502 surrounds the reusable, conductive aqueous solution reactive polymer 2504. The reusable, conductive aqueous solution reactive polymer 2504, just like the other reusable conductive aqueous solution reactive polymers disclosed herein, can be cleaned by various solutions to remove the aqueous solution and cause the reusable, conductive aqueous solution reactive polymer 2504 to shrink to a size so that it can be reused. This eliminates the cost of replacement of the aqueous solution leak detection cables disclosed herein. Sensor wire 2520 is surrounded by spacers 2524, 2526, 2528, and 2530 to securely locate the sensor wire 2520 in gap 2544 between the insulators 2506, 2508. The spacers 2524-2530 can be braided around the sensor wire 2520 and then placed in the recess between the insulators 2506, 2508. The spacers 2524-2530 create a gap 2544 (recess) between the sensor wire 2520 and conductive tube 2510. Similarly, spacers 2536, 2538, 2540, 2542 surround sensor wire 2522 and are braided around the sensor wire 2522. The braided sensor wire 2522 is then placed in the recess between the insulators 2506, 2508. A gap 2546 is formed between the conductive tube 2510 and the sensor wire 2522.

In operation, liquid and gas aqueous solution penetrate the non-expandable permeable cover 2502 and the protective cover 2518 illustrated in FIG. 25, and are absorbed by the reusable, conductive aqueous solution reactive polymer 2504. The reusable, conductive aqueous solution reactive polymer 2504 swells and expands inwardly so that the conductive tube 2510 is pushed inwardly, fills gap 2544, and contacts the sensor wire 2520. Similarly, the conductive tube 2510 is pushed inwardly and fills gap 2546, creating a short circuit between sensor wires 2520, 2522 at the location of the aqueous solution leak. The location of the aqueous solution leak is then determined by sensing a change in current on feedback conductors 2532, 2534, in the same manner as disclosed above.

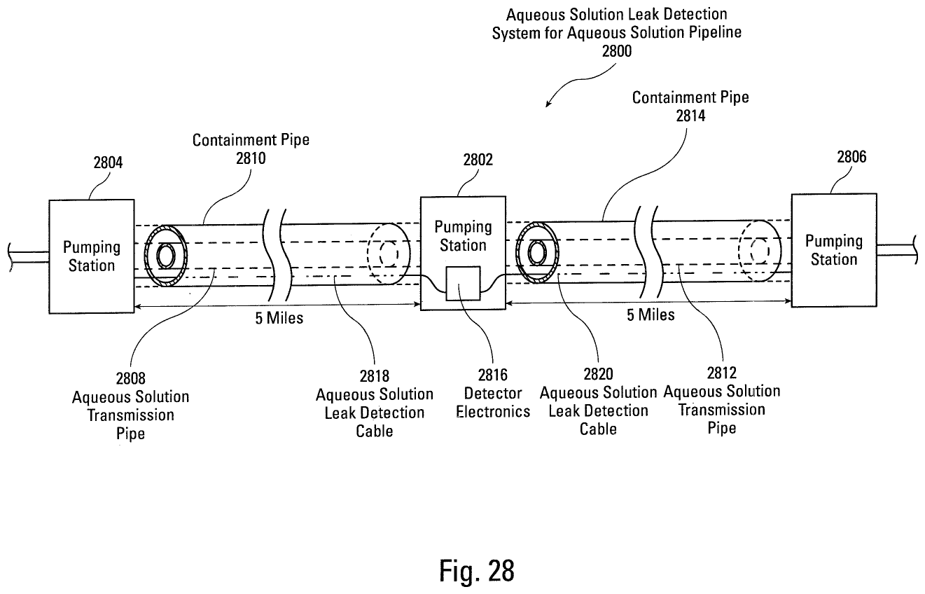

FIG. 28 is a schematic diagram of a aqueous solution leak detection system for aqueous solution pipeline 2800. As illustrated in FIG. 28, pumping stations 2802, 2804, 2806 are separated by about five miles. Aqueous solutions are pumped through the aqueous solution transmission pipes 2808, 2812. The containment pipe 2810 surrounds the aqueous solution transmission pipe 2808. Similarly, a containment pipe 2814 surrounds the aqueous solution transmission pipe 2812. The purpose of the containment pipes 2810, 2814 is to contain any leaks that occur in the aqueous solution transmission pipes 2808, 2812. Placed within the containment pipe 2810 is a aqueous solution leak detection cable 2818. Normally, the aqueous solution leak detection cable 2818 would be placed at the bottom of the containment pipe 2810 to contact any liquid aqueous solution that leak from the aqueous solution transmission pipe 2808 into the containment pipe 2810. Similarly, aqueous solution leak detection cable 2820 is placed within containment pipe 2814 at the bottom of the containment pipe 2814. Again, such placement is made for the purpose of contacting any liquid aqueous solution that leak from the aqueous solution transmission pipe 2812 and gather at the bottom of the containment pipe 2814. Pumping station 2802 includes detector electronics 2816 that are connected to aqueous solution leak detection cables 2818, 2820. As such, detector electronics 2816 can be used to detect leaks for at least five miles going in each direction from the pumping station 2802.

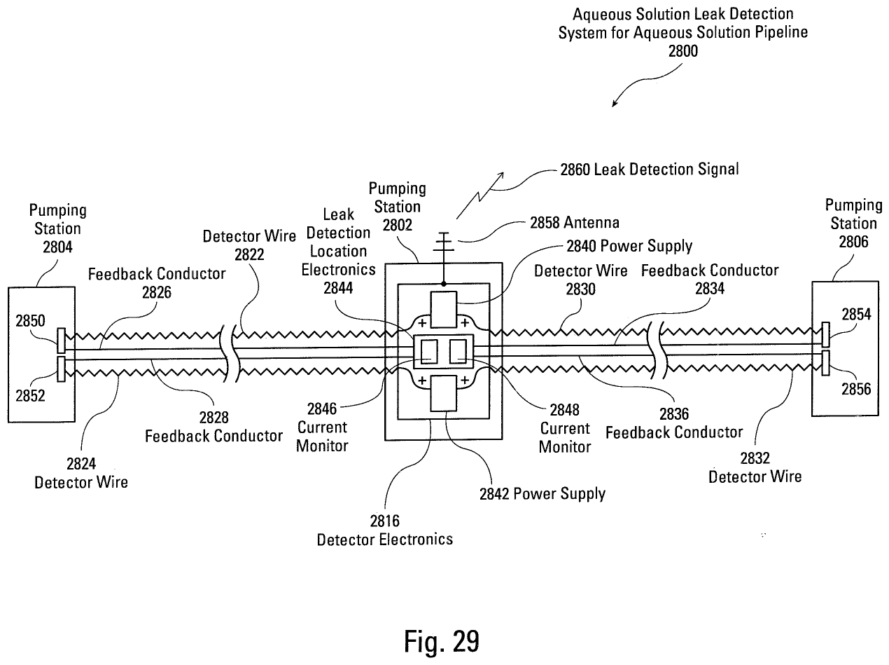

FIG. 29 is an additional schematic view of the aqueous solution leak detection system for aqueous solution pipeline 2800. As illustrated in FIG. 29, pumping station 2802 is located a distance, such as five miles, from pumping stations 2804, 2806. Feedback conductors 2826, 2828 are a portion of the feedback wire utilized in the various embodiments of the present invention. Detector wires 2822, 2824 are resistive wires that have a uniform resistance per unit length so that the location of a aqueous solution leak can be detected as a result of the detector wires 2822, 2824 being conductively connected, as explained above. Detector wire 2822 is conductively connected to the feedback conductor 2826 by the connector 2850 located in pumping station 2804. Similarly, detector wire 2824 is conductively connected to feedback conductor 2828 by the connector 2852 located in pumping station 2804. Detector wire 2830 is conductively connected to feedback conductor 2834 by connector 2854 located in pumping station 2806. Detector wire 2832 is conductively connected to feedback conductor 2836 in pumping station 2806 by connector 2856. A short between detector wires 2822, 2824, 2830, 2832, illustrated in FIG. 29, will create a change in current in feedback conductors 2826, 2828, 2834, 2836, which is detected by current monitors 2846, 2848. Power supply 2840 and power supply 2842 monitor any changes in current in feedback conductors 2826, 2828, 2834, 2836. Leak detection location electronics 2844 determines the location of the leak based upon the change in current monitored by current monitors 2846, 2848. Antenna 2858 generates a leak detection signal 2860 that is transmitted to a central detection station for alerting users of the leak.

Accordingly, the aqueous solution leak detection cables of the present invention provide a conductive method of determining the location of aqueous solution leaks. A reusable conductive aqueous solution reactive polymer is employed which can be cleaned using various solvents so that the aqueous solution leak detection cable does not need to be replaced. Alternatively, a aqueous solution reactive polymer that is not reusable, and requires replacement, can also be used. Changes in the amount of current provided through the feedback conductors allows for accurate detection of the location of the aqueous solution leak. The sensor wires are made from a resistive material which has a uniform resistance per unit length, that allows for the accurate detection of the location of the aqueous solution leak. The conductive method of detecting leaks is reliable and inexpensive and can be accurately used over long distances, in a manner that cannot be achieved using other methods. The various embodiments utilize a standard feedback wire that is used in many other applications, such as leak detectors for detecting moisture and aqueous solution leaks. The aqueous solution leak detection cable embodiments can be used between pumping stations on oil or gas pipelines that are spaced five miles apart or more. One set of electronics can be used at every other pumping station to detect leaks in a five mile direction going each way from the pumping station. The present disclosure indicates that the location of the leak can be detected by detecting changes in current over the sensor wires. Other techniques can be used, including a detection in change of resistance, voltage drops, or other techniques that are known in the art. These techniques are well known by those skilled in the art. These electronics can be connected wirelessly, or via a wire connection, to a central monitoring station that can provide immediate information as to the location of any leaks along an oil or gas pipeline. The same techniques can be used for aqueous solution storage containers. In that regard, although the present disclosure refers to liquid and gas aqueous solution, the reusable conductive aqueous solution reactive polymers disclosed herein can also be used with regard to various gases and operate in the same fashion.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. An aqueous solution leak detection cable comprising:
a feedback wire having feedback conductors and insulators surrounding said feedback conductors;
sensor wires disposed adjacent to said insulators and separated by said insulators, said sensor wires having a uniform resistance per unit of length;
a compressible conductive covering that surrounds said feedback wire and said sensor wires that is placed over said feedback wire and said sensor wire so that a gap is formed between said compressible conductive covering and said sensor wires;
an aqueous solution reactive polymer that expands in the presence of an aqueous solution that surrounds said compressible conductive covering;
a non-expandable permeable cover surrounding said aqueous solution reactive polymer that is permeable to an aqueous solution and directs forces from expansion of said aqueous solution reactive polymer, as a result of absorption of said aqueous solution, in an inward direction which causes said compressible conductive covering to move inwardly towards said sensor wires and contact said sensor wires to create electrical conduction between said sensor wires where said aqueous solution reactive polymer expands.

2. The aqueous solution leak detection cable of claim 1 wherein:
said compressible conductive covering comprises a conductive fabric braid.

3. The aqueous solution leak detection cable of claim 1 wherein:
said compressible conductive covering comprises a conductive tube.

4. The aqueous solution leak detection cable of claim 1 further comprising:
spacers disposed adjacent to said sensor wires to ensure that said gap exists between said compressible conductive covering and said sensor wires prior to expansion of said aqueous solution reactive polymer.

5. The aqueous solution leak detection cable of claim 4 wherein said spacers comprise two spacers located between each of said sensor wires and said compressible conductive covering.

6. The aqueous solution leak detection cable of claim 4 wherein said spacers comprise four spacers that are braided around each of said sensor wires.

7. An aqueous solution leak detection cable comprising:
a feedback wire having feedback conductors and insulators surrounding said feedback conductors;
sensor wires disposed adjacent to said insulators and separated by said insulators, said sensor wires having a uniform resistance per unit of length at said sensor wires;
a conductive aqueous solution reactive polymer placed over said feedback wire and said sensor wire that expands in the presence of aqueous solutions;
a non-expandable permeable cover surrounding said conductive aqueous solution reactive polymer that is permeable to aqueous solutions and directs forces from expansion of said conductive aqueous solution reactive polymer, as a result of absorption of aqueous solutions, in an inward direction which causes said conductive aqueous solution reactive polymer to move inwardly towards said sensor wires and contact said sensor wires to create electrical conduction between said sensor wires.

8. The aqueous solution leak detection cable of claim 7 further comprising:
spacers disposed adjacent to said sensor wires to ensure that said gap exists between said conductive aqueous solution reactive polymer and said sensor wires prior to expansion of said conductive aqueous solution reactive polymer.

9. The aqueous solution leak detection cable of claim 7 wherein said spacers comprise two spacers located between each of said sensor wires and said conductive aqueous solution reactive polymer.

10. The aqueous solution leak detection cable of claim 7 wherein said spacers comprise four spacers that are braided around each of said sensor wires.

11. A method of making an aqueous solution leak detection cable comprising:
providing feedback wire that has at least two feedback conductors;
providing insulators that surround said feedback conductors, said insulators connected to form recesses between said insulators;
placing sensor wires in said recesses between said conductors;
placing a compressible conductive covering over said insulators and said sensor wires so that a gap is formed between said sensor wires and said compressible conductive covering;
placing an aqueous solution reactive polymer over said compressible conductive covering that expands in the presence of aqueous solutions and creates forces on said compressible conductive covering to cause said compressible conductive covering to contact said sensor wires and create a conductive path between said sensor wires at a location where said aqueous solution reactive polymer has absorbed an aqueous solution from an aqueous solution leak;
placing a non-expandable permeable cover on said aqueous solution reactive polymer that protects said aqueous solution leak detection cable, and causes forces created by said aqueous solution reactive polymer, as a result of said aqueous solution reactive polymer expanding in the presence of aqueous solution, to be directed inwardly towards said compressible conductive covering.

12. The method of claim 11 wherein said method of placing a compressible conductive covering over said insulators and said sensor wires comprises:
placing a conductive fabric braid over said insulators and said sensor wires.

13. The method of claim 11 wherein said method of placing a compressible conductive covering over said insulators and said sensor wires comprises:
placing a conductive tube over said insulators and said sensor wires.

14. The method of claim 11 further comprising:
placing spacers adjacent to said sensor wires to ensure that said gap exists between said compressible conductive covering and said sensor wires.

15. The method of claim 14 wherein said method of placing spacers adjacent to said sensor wires comprises:
placing two spacers adjacent to each of said sensor wires that are located between each of said sensor wires and said compressible conductive covering.

16. The method of claim 14 wherein said method of placing spacers adjacent to said sensor wires comprises:
placing four spacers adjacent to each of said sensor wires that are braided around said sensor wires.

17. A method of making an aqueous solution leak detection cable comprising:
providing feedback wire that has at least two feedback conductors;
providing insulators that surround said feedback conductors, said insulators connected to form recesses between said insulators;
placing sensor wires in said recesses between said conductors;
placing a conductive aqueous solution reactive polymer over said sensor wires and said insulators that expands in the presence of an aqueous solution and creates forces on said compressible conductive covering to cause said compressible conductive covering to contact said sensor wires and create a conductive path between said sensor wires at a location where said conductive aqueous solution reactive polymer has absorbed an aqueous solution from an aqueous solution leak;
placing a non-expandable permeable cover on said conductive aqueous solution reactive polymer that protects said aqueous solution leak detection cable and causes forces created by said conductive aqueous solution reactive polymer, as a result of said conductive aqueous solution reactive polymer expanding in the presence of an aqueous solution, to be directed inwardly towards said compressible conductive covering.

18. The method of claim 17 further comprising:
placing spacers adjacent to said sensor wires to ensure that said gap exists between said compressible conductive covering and said sensor wires.

19. The method of claim 17 wherein said method of placing spacers adjacent to said sensor wires comprises:
placing two spacers adjacent to each of said sensor wires that are located between each of said sensor wires and said conductive aqueous solution reactive polymer.

20. The method of claim 17 wherein said method of placing spacers adjacent to said sensor wires comprises:
placing four spacers adjacent to each of said sensor wires that are braided around said sensor wires.

21. A method of making an aqueous solution leak detection cable comprising:
providing a feedback wire having feedback conductors and insulators surrounding said feedback conductors;
placing sensor wires adjacent to said insulators;
placing a compressible conductive covering that surrounds said feedback wire and said sensor wires so that gaps are created between said sensor wires and said compressible conductive covering;
placing a layer of an aqueous solution reactive polymer over said compressible conductive covering that expands in the presence of aqueous solutions and causes said compressive conductor to extend into said gaps and create a conductive path between said sensor wires.

22. The method of claim 21 further comprising:
placing spacers adjacent to said sensor wires to ensure said gaps are created.

23. A method of detecting a location of an aqueous solution leak in an aqueous solution leak detection cable comprising:
using a layer of aqueous solution reactive polymer that surrounds a compressible conductive covering so that a gap is formed between said aqueous solution reactive polymer, said compressible conductive covering placed over sensor wires so that a gap is formed between said compressible conductive covering and said sensor wires;
detecting an aqueous solution leak at said location on said aqueous solution leak detection cable by allowing a liquid aqueous solution from said aqueous solution leak to penetrate said aqueous solution leak detection cable at said location causing said aqueous solution reactive polymer to absorb said liquid aqueous solution, which causes said aqueous solution reactive polymer to swell so that said compressible conductive covering extends into said gaps and creates a conductive path between said sensor wires at said location;
using detector electronics to determine where on said aqueous solution leak detection cable said conductive path has occurred to determine said location of said aqueous solution leak.

24. A method of making an aqueous solution leak detection cable comprising:
providing a feedback wire having feedback conductors and insulators surrounding said feedback conductors;
placing sensor wires adjacent to said insulators;
placing a layer of a conductive aqueous solution reactive polymer over said feedback wire and said sensor wires so that gaps are created between said sensor wires and said conductive aqueous solution reactive polymer, said conductive aqueous solution reactive polymer expanding in the presence of an aqueous solution and extending into said gaps to create an electrically conductive path between said sensor wires.

25. The method of claim 24 further comprising:
placing spacers adjacent to said sensor wires to ensure said gaps are created.

26. A method of detecting a location of an aqueous solution leak in an aqueous solution leak detection cable comprising:
placing a layer of a conductive aqueous solution reactive polymer on resistive sensor wires that covers resistive sensor wires in said aqueous solution leak detection cable;
detecting an aqueous solution leak at said location on said aqueous solution leak detection cable by allowing an aqueous solution from said aqueous solution leak to penetrate said aqueous solution leak detection cable at said location causing said conductive aqueous solution reactive polymer to absorb said aqueous solution, which causes said conductive aqueous solution reactive polymer to swell and expand into gaps between said conductive aqueous solution reactive polymer and said resistive sensor wires to create an electrically conductive path between said sensor wires at said location;
using detector electronics to determine where on said aqueous solution leak detection cable said conductive path has occurred to determine said location of said aqueous solution leak.
